(19) United States
(12) Patent Application Publication
(10) Pub. No.: US 2014/0192061 A1
(43) Pub. Date: Jul. 10, 2014

(54) ELECTROMECHANICAL SYSTEMS HAVING SIDEWALL BEAMS

(71) Applicant: PIXTRONIX, INC., San Diego, CA (US)

(72) Inventors: Richard S. Payne, Andover, MA (US); Nesbitt W. Hagood, Wellesley, MA (US); Timothy J. Brosnihan, Natick, MA (US); Joyce H. Wu, Somerville, MA (US); Mark B. Andersson, Northborough, MA (US); Jasper Lodewyk Steyn, Winchester, MA (US)

(73) Assignee: Pixtronix, Inc., San Diego, CA (US)

(21) Appl. No.: 13/737,439

(22) Filed: Jan. 9, 2013

(51) Int. Cl. G02B 26/02; G06T 1/00

(52) U.S. Cl. CPC G02B 26/02; G06T 1/00
USPC 345/501; 359/230; 29/25.41

(57) ABSTRACT

This disclosure provides systems, methods and apparatus for electromechanical systems having sidewalls beams. In one aspect, a device includes a substrate having a first electrode and a second electrode, and a movable shuttle monolithically integrated with the substrate, and having a first wall, a second wall, and a base. The first and second walls each have a first dimension at least four times larger than a second dimension. The first and second walls define substantially parallel vertical sides of the shuttle, and the base is positioned orthogonally to the first and second walls and forms a horizontal bottom of the shuttle, providing structural support to the first and second walls. The first wall and the first electrode define a first capacitor, and the second wall and the second electrode define a second capacitor.

### TECHNICAL FIELD

This disclosure relates to electromechanical systems and devices, and the formation of electromechanical sensors and actuators.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

MEMS are typically fabricated using older silicon-based integrated circuit-processing equipment. Glass-based manufacturing technologies have been difficult to exploit because conventional MicroElectroMechanical device fabrication methods are often incompatible with glass-based display technology. Also, stress and stress gradient issues associated with conventional Integrated Circuit (IC) fabrication can be exacerbated in large-scale glass-based microfabrication.

### SUMMARY

The systems, methods and devices of this disclosure each have several innovative aspects, no single one of which is solely responsible for the desirable attributes disclosed herein.

One innovative aspect of the subject matter described in this disclosure can be implemented in a device including a substrate having a first electrode and a second electrode, and a movable shuttle monolithically integrated with the substrate, and having a first wall, a second wall, and a base. The first and second walls each have a first dimension at least four times larger than a second dimension. The first and second walls define substantially parallel vertical sides of the shuttle, and the base is positioned orthogonally to the first and second walls and forms a horizontal bottom of the shuttle. The first wall and the first electrode define a first capacitor, and the second wall and the second electrode define a second capacitor.

In some implementations, the base can provide structural support to the first and second walls and limits movement of the first and second walls. In some implementations, the first wall faces the first electrode in a first direction and the second wall faces the second electrode in a second opposite direction, to provide a differential capacitor sensor. In some implementations, the substrate can include a transparent section, and the movable shuttle includes a microelectromechanical (MEM) shutter element for modulating light passing through the transparent section of the substrate. In some implementations, the movable shuttle can include a transducer of a component selected from a group comprising at least one of an accelerometer, a speaker, a microphone, and a pressure sensor. In some implementations, the device can include a microelectricalmechanical systems (MEMS) gyroscope array monolithically integrated with the substrate and configured to measure an orientation of the device.

Another innovative aspect of the subject matter described in this disclosure can be implemented in a method of manufacturing an electromechanical device, including providing a substrate having a first electrode and a second electrode, and monolithically forming a movable shuttle on the substrate. Forming the shuttle includes forming a first wall and a second wall, each defining a vertical side of the shuttle and each having a first dimension at least four times larger than a second dimension, and forming a base positioned orthogonally to the first and second walls and defining a horizontal bottom of the shuttle, wherein the first and second walls are coupled to the base to form a corrugated structure. The first wall and the first electrode define a first capacitor, and the second wall and the second electrode define a second capacitor.

In some implementations, forming the first wall includes forming the first wall to face the first electrode in a first direction, and forming the second wall includes forming the second wall to face the second electrode in a second opposite direction. The method can further include configuring the first and the second capacitors to provide a differential capacitor sensor. In some implementations, monolithically forming the movable shuttle can include providing a MEM shutter element for modulating light passing through a transparent section of the substrate. In some implementations, monolithically forming the movable shuttle can include providing a transducer of a component selected from a group consisting of an accelerometer, a speaker, a microphone, and a pressure sensor.

In some implementations, the method can include providing a tether beam monolithically integrated with the substrate and configured to hold the movable shuttle relative to the substrate. In some implementations, providing the substrate can include providing an insulator selected from the group comprising at least one of glass, fused silica, an insulating ceramic, and a polymeric insulator.

Another innovative aspect of the subject matter described in this disclosure can be implemented in a display including a substrate having a first electrode and a second electrode, a plurality of microelectromechanical system (MEMS) shutters disposed on the substrate and configured to modulate light, and a movable shuttle monolithically integrated with the substrate, and having a first wall, a second wall, and a base. The first and second walls each have a first dimension at least four times larger than a second dimension, and wherein the first wall, the second wall, and the base are coupled to substantially define a U-shape. The first wall and the first electrode define a first capacitor, and the second wall and the second electrode define a second capacitor.

In some implementations, the movable shuttle can include a transducer of a component selected from a group including at least one of an accelerometer, a speaker, a microphone, a tilt sensor, and a pressure sensor. In some implementations, the first and second walls can define parallel vertical sides of the shuttle, the base can be positioned orthogonally to the first and second walls, and the base can provide support to the first and second walls and can limit movement of the first and second walls. In some implementations, the first wall can face the first electrode in a first direction and the second wall can face the second electrode in a second opposite direction, to provide a differential capacitor sensor. In some implementations, the substrate can include an insulator selected from the group including at least one of glass, fused silica, an insulating ceramic, and a polymeric insulator.

In some implementations, the display can include a tether beam monolithically integrated with the substrate and configured to hold the movable shuttle relative to the substrate. In some implementations, the display can include a MEMS gyroscope array disposed on the substrate and configured to measure an orientation of the display, the MEMS gyroscope array including at least one gyroscope incorporating the movable shuttle.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays (LCDs), organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

The foregoing discussion will be understood more readily from the following detailed description with reference to the following drawings

FIG. 1A is an isometric view of an example display apparatus;

FIG. 1B is a block diagram of the display apparatus of FIG. 1A;

FIG. 2 is a perspective view of an illustrative shutter-based light modulator suitable for incorporation into the MEMS-based display of FIG. 1A;

FIG. 3A is a schematic diagram of a control matrix suitable for controlling the light modulators incorporated into the MEMS-based display of FIG. 1A;

FIG. 3B is a perspective view of an array of shutter-based light modulators connected to the control matrix of FIG. 3A;

FIGS. 4A and 4B are plan views of a dual-actuated shutter assembly in the open and closed states respectively;

FIG. 5 is a cross-sectional view of a shutter-based display apparatus;

FIGS. 6A and 6B are system block diagrams illustrating a display device 40 that includes a plurality of light modulator display elements;

FIG. 7 is an example of a MEMS system;

FIGS. 8A-8E are schematic drawings of a cross-sectional view of a region of a substrate including a sidewall beam at different stages of fabrication, according to one example;

FIG. 9A is a top view of an example of a sensor structure including electrodes;

FIG. 9B is a cross-sectional view of an example of a sensor structure including electrodes;

FIG. 10 is a cross-sectional view of a sensor having a cover, according to one example;

FIG. 11A is a top view of an example of a sensor structure including electrodes;

FIG. 11B is a cross-sectional view of an example of a sensor structure including electrodes;

FIG. 12 is a cross-sectional view of an example of a set of shutters and an accelerometer formed on a substrate;

FIG. 13 is a flowchart of a method of manufacturing an electromechanical device, according to one example;

FIG. 14 is a perspective view of a MEMS gyroscope array; and

FIG. 15 is a perspective view of an array of MEMS elements including gyroscope elements and a shutter.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Systems and methods are disclosed herein for providing glass-based devices having a capacitive element, and for fabricating such devices. The devices include a capacitive element and a movable shuttle, and are formed from conventional glass-based display fabrication processes. The devices may include micromechanical devices and MEMS devices. In one implementation, the devices are MEMS shutter displays having additional components integrated on the display substrate, such as accelerometers, gyroscopes, speakers and microphones.

In one implementation, a device includes a substrate having first and second electrodes, and a movable shuttle monolithically integrated with the substrate. The movable shuttle has first and second walls, which define substantially parallel vertical sides of the shuttle, and a base positioned orthogonally to the first and second walls and forming a horizontal bottom of the shuttle. The first wall and the first electrode define a first capacitor, and the second wall and the second electrode define a second capacitor. In this implementation, the first and second walls have a first dimension at least four times larger than a second dimension. In one implementation, the base provides structural support to the first and second walls, and limits movement of the first and second walls. The movable shuttle may be part of one or more of an accelerometer, a gyroscope, a speaker, a microphone and a pressure sensor.

According to various implementations, the systems and methods disclosed herein allow for the formation of a variety of micromechanical actuators and sensors that include a corrugated structure, such as a shuttle. According to one advantage, systems and methods are provided for glass-based display fabrication platforms including micromechanical structures that are less expensive to produce than structures produced using conventional silicon-based methods and designs.

According to certain implementations, the use of conventional glass-based display fabrication technology to fabricate microsystems facilitates the monolithic integration of displays, sensors, actuators, and interface circuitry. As a result, implementations can be used for the development of fully integrated systems such as displays, accelerometers, microphones, speakers, pressure sensors, energy scavenging devices, mechanical resonators, or any combination thereof. Accelerometers may be used, for example, for gesture recognition or tilt-sensing.

The glass-based structures disclosed herein integrate functional components into the display system, thereby reducing device costs by eliminating the addition of discrete functional components into the display system for providing the functionality. Additionally, while the design rules for glass device fabrication are larger than for comparable silicon based structures, the cost for glass device fabrication is about one hundred times lower than the cost for comparable silicon based device fabrication. In one example, mobile phones typically have one or more accelerometers, and integrating the accelerometers into the display system can result in a cost savings, which can be especially significant for mass productions of devices. In other examples, microphones, speakers, gyroscopes and magnetometers may be integrated into the display system. In various implementations, accelerometers, gyroscopes and magnetometers may be used, for example, for tilt, gesture, GPS fill in, and games integration.

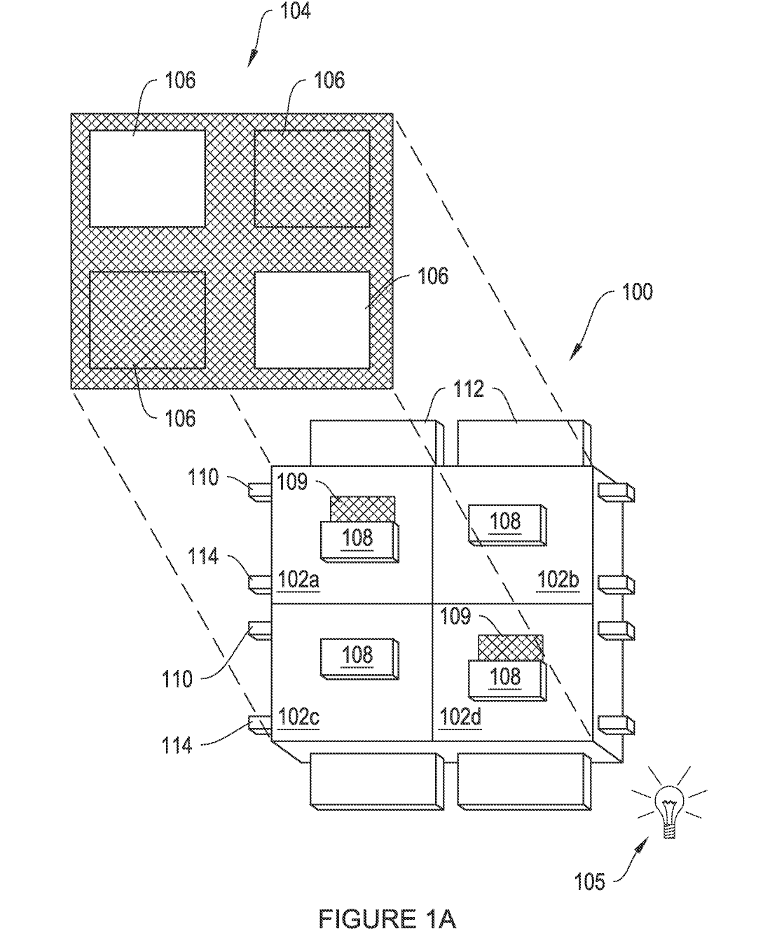

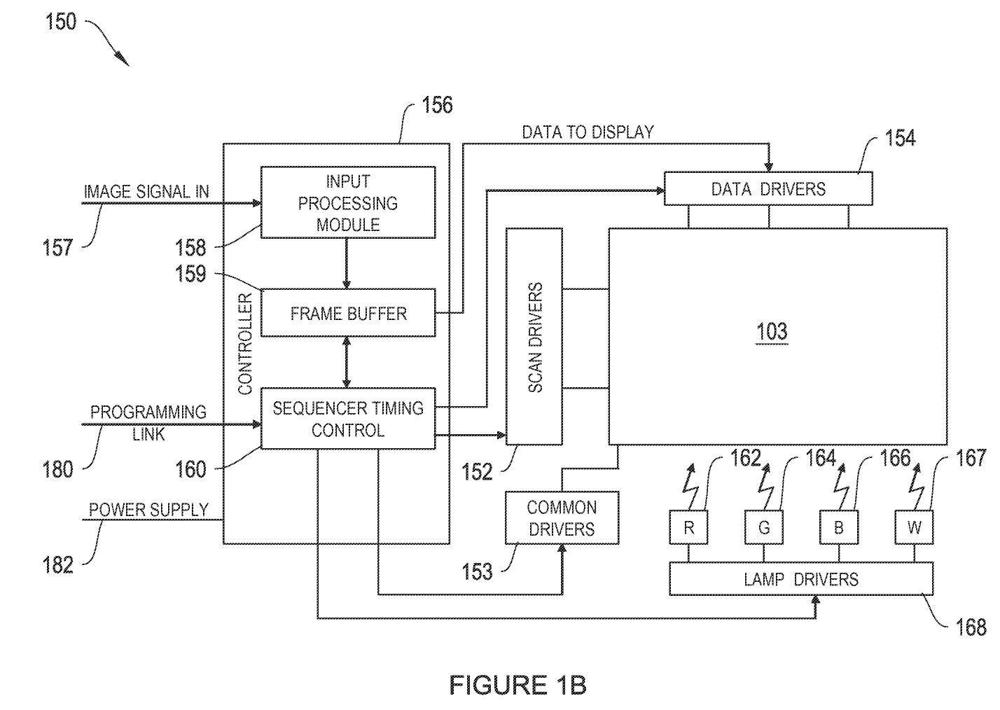

FIG. 1A is a schematic diagram of a direct-view MEMS-based display apparatus 100. The display apparatus 100 includes a plurality of light modulators 102a-102d (generally “light modulators 102”) arranged in rows and columns. The MEMS-based display apparatus 100 may be a glass-based device, and may include integrated capacitive elements. In the display apparatus 100, light modulators 102a and 102d are in the open state, allowing light to pass. Light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e. by use of a frontlight. In one of the closed or open states, the light modulators 102 interfere with light in an optical path by, for example, and without limitation, blocking, reflecting, absorbing, filtering, polarizing, diffracting, or otherwise altering a property or path of the light.

In the display apparatus 100, each light modulator 102 corresponds to a pixel 106 in the image 104. In other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide grayscale in an image 104. With respect to an image, a “pixel” corresponds to the smallest picture element defined by the resolution of the image. With respect to structural components of the display apparatus 100, the term “pixel” refers to the combined mechanical and electrical components utilized to modulate the light that forms a single pixel of the image.

Display apparatus 100 is a direct-view display in that it does not require imaging optics. The user sees an image by looking directly at the display apparatus 100. In alternate implementations the display apparatus 100 is incorporated into a projection display. In such implementations, the display forms an image by projecting light onto a screen or onto a wall. In projection applications the display apparatus 100 is substantially smaller than the projected image 104.

Direct-view displays may operate in either a transmissive or reflective mode. In a transmissive display, the light modulators filter or selectively block light which originates from a lamp or lamps positioned behind the display. The light from the lamps is optionally injected into a light guide or “backlight”. Transmissive direct-view display implementations are often built onto transparent or glass substrates to facilitate a sandwich assembly arrangement where one substrate, containing the light modulators, is positioned directly on top of the backlight. In some transmissive display implementations, a color-specific light modulator is created by associating a color filter material with each modulator 102. In other transmissive display implementations colors can be generated, as described below, using a field sequential color method by alternating illumination of lamps with different primary colors.

Each light modulator 102 includes a shutter 108 and an aperture 109. To illuminate a pixel 106 in the image 104, the shutter 108 is positioned such that it allows light to pass through the aperture 109 towards a viewer. To keep a pixel 106 unlit, the shutter 108 is positioned such that it obstructs the passage of light through the aperture 109. The aperture 109 is defined by an opening patterned through a reflective or light-absorbing material.

The display apparatus also includes a control matrix connected to the substrate and to the light modulators for controlling the movement of the shutters. The control matrix includes a series of electrical interconnects (e.g., interconnects 110, 112, and 114), including at least one write-enable interconnect 110 (also referred to as a “scan-line interconnect”) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the “write-enabling voltage, V_{we}”), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In other implementations, the data voltage pulses control switches, e.g., transistors or other non-linear circuit elements that control the application of separate actuation voltages, which are typically higher in magnitude than the data voltages, to the light modulators 102. The application of these actuation voltages then results in the electrostatic driven movement of the shutters 108.

FIG. 1B is a block diagram 150 of the display apparatus 100. Referring to FIGS. 1A and 1B, in addition to the elements of the display apparatus 100 described above, as depicted in the block diagram 150, the display apparatus 100 includes a plurality of scan drivers 152 (also referred to as “write enabling voltage sources”) and a plurality of data drivers 154 (also referred to as “data voltage sources”). The scan drivers 152 apply write enabling voltages to scan-line interconnects 110. The data drivers 154 apply data voltages to the data interconnects 112. In some implementations of the display apparatus, the data drivers 154 are configured to provide analog data voltages to the light modulators, especially where the gray scale of the image 104 is to be derived in analog fashion. In analog operation the light modulators 102 are designed such that when a range of intermediate voltages is applied through the data interconnects 112 there results a range of intermediate open states in the shutters 108 and therefore a range of intermediate illumination states or gray scales in the image 104.

In other cases the data drivers 154 are configured to apply only a reduced set of 2, 3, or 4 digital voltage levels to the control matrix. These voltage levels are designed to set, in digital fashion, either an open state or a closed state to each of the shutters 108.

The scan drivers 152 and the data drivers 154 are connected to digital controller circuit 156 (also referred to as the “controller 156”). The controller 156 includes an input processing module 158, which processes an incoming image signal 157 into a digital image format appropriate to the spatial addressing and the gray scale capabilities of the display 100. The pixel location and gray scale data of each image is stored in a frame buffer 159 so that the data can be fed out as needed to the data drivers 154. The data is sent to the data drivers 154 in mostly serial fashion, organized in predetermined sequences grouped by rows and by image frames. The data drivers 154 can include series to parallel data converters, level shifting, and for some applications digital to analog voltage converters.

The display 100 apparatus optionally includes a set of common drivers 153, also referred to as common voltage sources. In some implementations the common drivers 153 provide a DC common potential to all light modulators within the array of light modulators 103, for instance by supplying voltage to a series of common interconnects 114. In other implementations the common drivers 153, following commands from the controller 156, issue voltage pulses or signals to the array of light modulators 103, for instance global actuation pulses which are capable of driving and/or initiating simultaneous actuation of all light modulators in multiple rows and columns of the array 103.

All of the drivers (e.g., scan drivers 152, data drivers 154, and common drivers 153) for different display functions are time-synchronized by a timing-control module 160 in the controller 156. Timing commands from the module 160 coordinate the illumination of red, green and blue and white lamps (162, 164, 166, and 167 respectively) via lamp drivers 168, the write-enabling and sequencing of specific rows within the array of pixels 103, the output of voltages from the data drivers 154, and the output of voltages that provide for light modulator actuation.

The controller 156 determines the sequencing or addressing scheme by which each of the shutters 108 in the array 103 can be re-set to the illumination levels appropriate to a new image 104. New images 104 can be set at periodic intervals. For instance, for video displays, the color images 104 or frames of video are refreshed at frequencies ranging from 10 to 300 Hertz. In some implementations, the setting of an image frame to the array 103 is synchronized with the illumination of the lamps 162, 164, and 166 such that alternate image frames are illuminated with an alternating series of colors, such as red, green, and blue. The image frames for each respective color is referred to as a color sub-frame. In this method, referred to as the field sequential color method, if the color sub-frames are alternated at frequencies in excess of 20 Hz, the human brain will average the alternating frame images into the perception of an image having a broad and continuous range of colors. In alternate implementations, four or more lamps with primary colors can be employed in display apparatus 100, employing primaries other than red, green, and blue.

In some implementations, where the display apparatus 100 is designed for the digital switching of shutters 108 between open and closed states, the controller 156 determines the addressing sequence and/or the time intervals between image frames to produce images 104 with appropriate gray scale. The process of generating varying levels of grayscale by controlling the amount of time a shutter 108 is open in a particular frame is referred to as time division gray scale. In some implementations of time division gray scale, the controller 156 determines the time period or the fraction of time within each frame that a shutter 108 is allowed to remain in the open state, according to the illumination level or gray scale desired of that pixel. In other implementations, for each image frame, the controller 156 sets a plurality of sub-frame images in multiple rows and columns of the array 103, and the controller alters the duration over which each sub-frame image is illuminated in proportion to a gray scale value or significance value employed within a coded word for gray scale. For instance, the illumination times for a series of sub-frame images can be varied in proportion to the binary coding series 1,2,4,8 . . . . The shutters 108 for each pixel in the array 103 are then set to either the open or closed state within a sub-frame image according to the value at a corresponding position within the pixel's binary coded word for gray level.

In other implementations, the controller alters the intensity of light from the lamps 162, 164, and 166 in proportion to the gray scale value desired for a particular sub-frame image. A number of hybrid techniques are also available for forming colors and gray scale from an array of shutters 108. For instance, the time division techniques described above can be combined with the use of multiple shutters 108 per pixel, or the gray scale value for a particular sub-frame image can be established through a combination of both sub-frame timing and lamp intensity. In some implementations, the data for an image state 104 is loaded by the controller 156 to the modulator array 103 by a sequential addressing of individual rows, also referred to as scan lines.

For each row or scan line in the sequence, the scan driver 152 applies a write-enable voltage to the write enable interconnect 110 for that row of the array 103, and subsequently the data driver 154 supplies data voltages, corresponding to desired shutter states, for each column in the selected row. This process repeats until data has been loaded for all rows in the array. In some implementations the sequence of selected rows for data loading is linear, proceeding from top to bottom in the array. In other implementations, the sequence of selected rows is pseudo-randomized, in order to minimize visual artifacts. In further implementations, the sequencing is organized by blocks, where, for a block, the data for only a certain fraction of the image state 104 is loaded to the array, for instance by addressing only every 5^{th} row of the array in sequence.

In some implementations, the process for loading image data to the array 103 is separated in time from the process of actuating the shutters 108. In these implementations, the modulator array 103 may include data memory elements for each pixel in the array 103 and the control matrix may include a global actuation interconnect for carrying trigger signals, from common driver 153, to initiate simultaneous actuation of shutters 108 according to data stored in the memory elements. Various addressing sequences can be coordinated by means of the timing control module 160.

In alternative implementations, the array of pixels 103 and the control matrix that controls the pixels may be arranged in configurations other than rectangular rows and columns. For example, the pixels can be arranged in hexagonal arrays or curvilinear rows and columns. In general, as used herein, the term scan-line shall refer to any plurality of pixels that share a write-enabling interconnect.

The display 100 includes of a plurality of functional blocks including the timing control module 160, the frame buffer 159, scan drivers 152, data drivers 154, and drivers 153 and 168. Each block can be understood to represent either a distinguishable hardware circuit and/or a module of executable code. In some implementations the functional blocks are provided as distinct chips or circuits connected together by means of circuit boards and/or cables. Alternately, many of these circuits can be fabricated along with the pixel array 103 on the same substrate of glass or plastic. In other implementations, multiple circuits, drivers, processors, and/or control functions from block diagram 150 may be integrated together within a single silicon chip, which is then bonded directly to the transparent substrate holding pixel array 103.

The controller 156 includes a programming link 180 by which the addressing, color, and/or gray scale algorithms, which are implemented within controller 156, can be altered according to the needs of particular applications. In some implementations, the programming link 180 conveys information from environmental sensors, such as ambient light or temperature sensors, so that the controller 156 can adjust imaging modes or backlight power in correspondence with environmental conditions. The controller 156 also includes a power supply input 182 which provides the power needed for lamps as well as light modulator actuation. Where necessary, the drivers 152, 153, 154, and/or 168 may include or be associated with DC-DC converters for transforming an input voltage at 182 into various voltages sufficient for the actuation of shutters 108 or illumination of the lamps, such as lamps 162, 164, 166, and 167.

MEMS Light Modulators

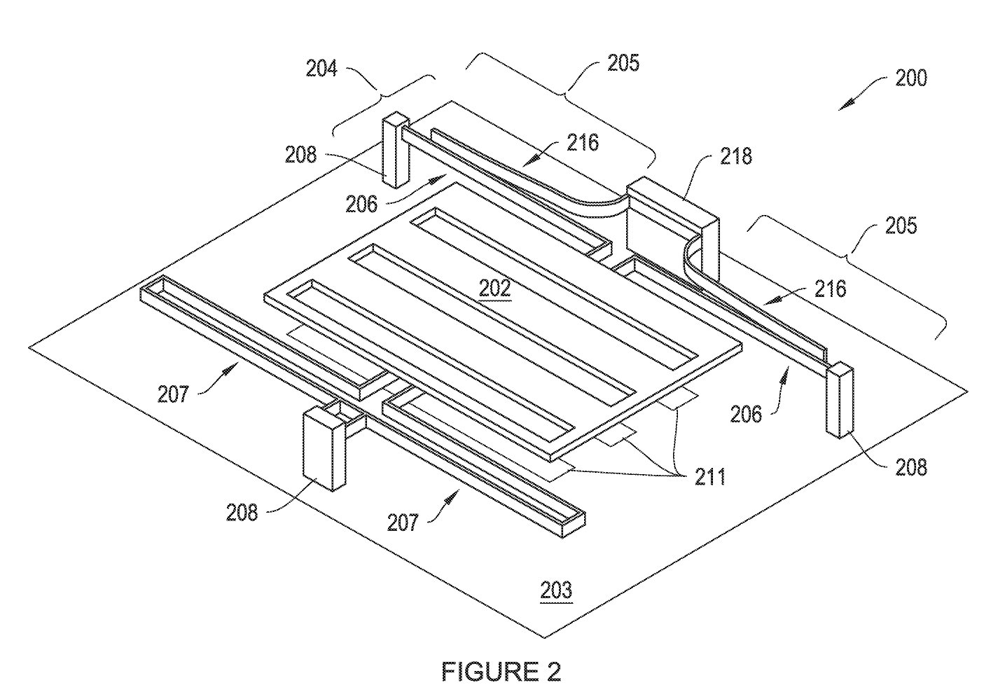

FIG. 2 is a perspective view of an illustrative shutter-based light modulator 200 suitable for incorporation into the MEMS-based display apparatus 100 of FIG. 1A. The light modulator 200 may be formed from glass. The shutter-based light modulator 200 (also referred to as shutter assembly 200) includes a shutter 202 coupled to an actuator 204. The actuator 204 is formed from two separate compliant electrode beam actuators 205 (the “actuators 205”). The shutter 202 couples on one side to the actuators 205. The actuators 205 move the shutter 202 transversely over a surface 203 in a plane of motion which is substantially parallel to the surface 203. The opposite side of the shutter 202 couples to a spring 207 which provides a restoring force opposing the forces exerted by the actuator 204. In some implementations, the shutter 202 may be corrugated, as described in greater detail below. In some applications, the light modulator 200 may include capacitive elements.

Each actuator 205 includes a compliant load beam 206 connecting the shutter 202 to a load anchor 208. The load anchors 208 along with the compliant load beams 206 serve as mechanical supports, keeping the shutter 202 suspended proximate to the surface 203. The load anchors 208 physically connect the compliant load beams 206 and the shutter 202 to the surface 203 and electrically connect the load beams 206 to a bias voltage, in some instances, ground.

Each actuator 205 also includes a compliant drive beam 216 positioned adjacent to each load beam 206. The drive beams 216 couple at one end to a drive beam anchor 218 shared between the drive beams 216. The other end of each drive beam 216 is free to move. Each drive beam 216 is curved such that it is closest to the load beam 206 near the free end of the drive beam 216 and the anchored end of the load beam 206.

The surface 203 includes one or more apertures 211 for admitting the passage of light. If the shutter assembly 200 is formed on an opaque substrate, made for example from silicon, then the surface 203 is a surface of the substrate, and the apertures 211 are formed by etching an array of holes through the substrate. If the shutter assembly 200 is formed on a transparent substrate, made for example of glass or plastic, then the surface 203 is a surface of a light blocking layer deposited on the substrate, and the apertures are formed by etching the surface 203 into an array of holes 211. The apertures 211 can be generally circular, elliptical, polygonal, serpentine, or irregular in shape.

In operation, a display apparatus incorporating the light modulator 200 applies an electric potential to the drive beams 216 via the drive beam anchor 218. A second electric potential may be applied to the load beams 206. The resulting potential difference between the drive beams 216 and the load beams 206 pulls the free ends of the drive beams 216 towards the anchored ends of the load beams 206, and pulls the shutter ends of the load beams 206 toward the anchored ends of the drive beams 216, thereby driving the shutter 202 transversely towards the drive anchor 218. The compliant members 206 act as springs, such that when the voltage across the beams 206 and 216 is removed, the load beams 206 push the shutter 202 back into its initial position, releasing the stress stored in the load beams 206.

The shutter assembly 200, also referred to as an elastic shutter assembly, incorporates a passive restoring force, such as a spring, for returning a shutter to its rest or relaxed position after voltages have been removed. A number of elastic restore mechanisms and various electrostatic couplings can be designed into or in conjunction with electrostatic actuators, the compliant beams illustrated in shutter assembly 200 being just one example. Other examples are described in U.S. patent application Ser. Nos. 11/251,035 and 11/326,696, the entireties of which are incorporated herein by reference. For instance, a highly non-linear voltage-displacement response can be provided which favors an abrupt transition between “open” vs. “closed” states of operation, and which, in many cases, provides a bi-stable or hysteretic operating characteristic for the shutter assembly. Other electrostatic actuators can be designed with more incremental voltage-displacement responses and with considerably reduced hysteresis, as may be used for analog gray scale operation.

The actuator 205 within the elastic shutter assembly is said to operate between a closed or actuated position and a relaxed position. The designer, however, can choose to place apertures 211 such that shutter assembly 200 is in either the “open” state, i.e. passing light, or in the “closed” state, i.e. blocking light, whenever actuator 205 is in its relaxed position. For illustrative purposes, it is assumed below that elastic shutter assemblies described herein are designed to be open in their relaxed state.

In many cases, a dual set of “open” and “closed” actuators may be provided as part of a shutter assembly so that the control electronics are capable of electrostatically driving the shutters into each of the open and closed states.

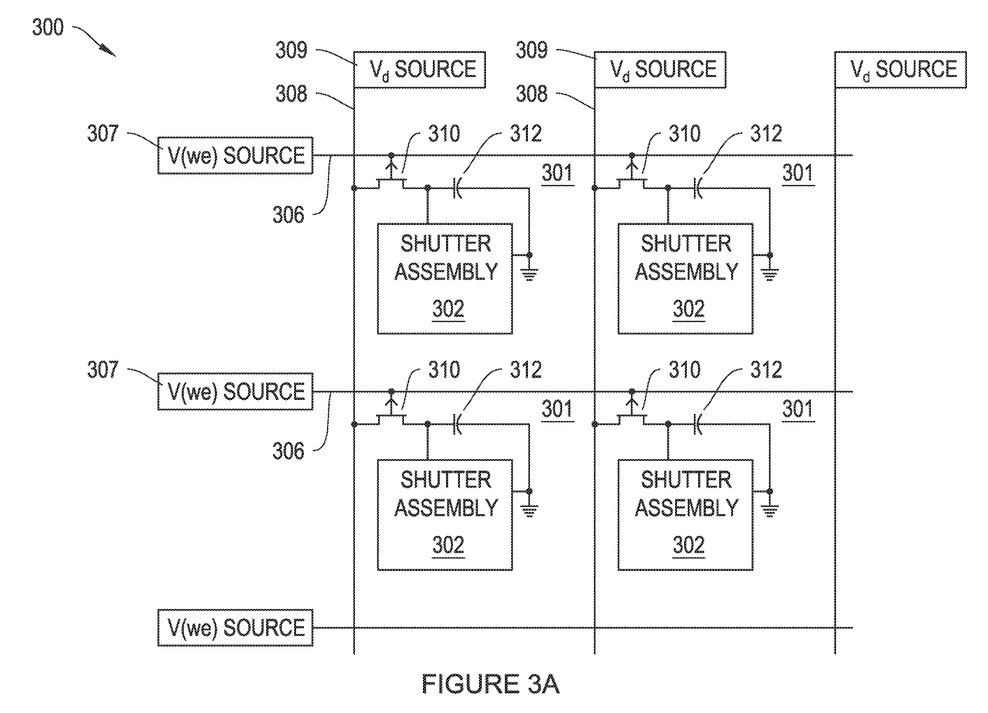

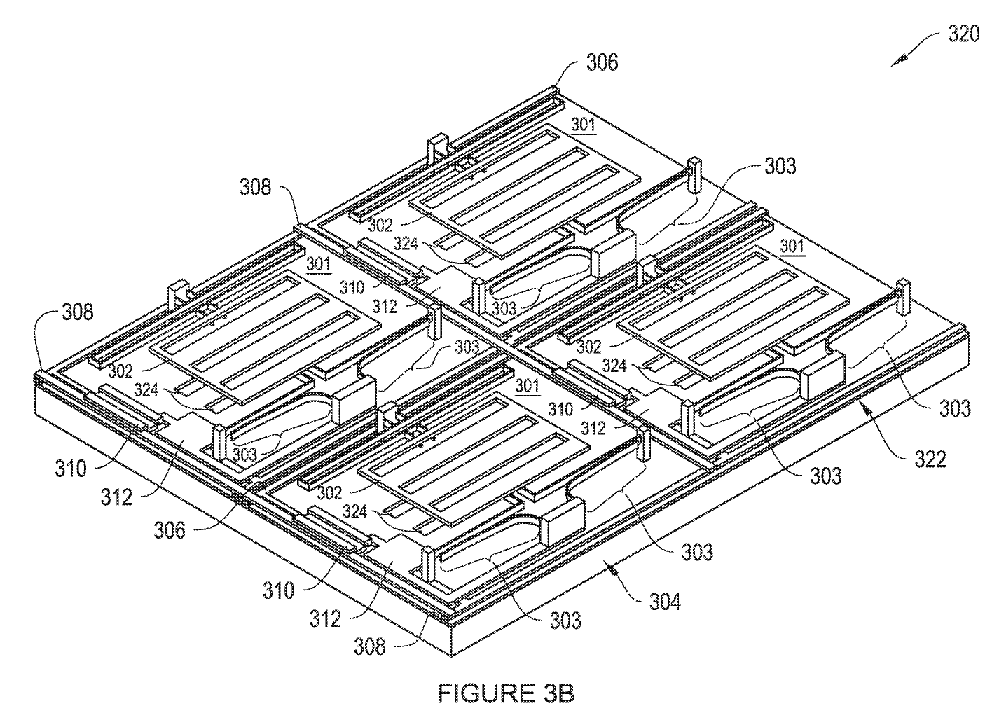

FIG. 3A is a schematic diagram of a control matrix 300 suitable for controlling the light modulators incorporated into the MEMS-based display apparatus 100 of FIG. 1A. In some implementations, the control matrix may be used to control a corrugated shuttle matrix, which includes corrugated shuttles as described in greater detail below. FIG. 3B is a perspective view of an array 320 of shutter-based light modulators connected to the control matrix 300 of FIG. 3A. The control matrix 300 may address an array of pixels 320 (the “array 320”). Each pixel 301 includes an elastic shutter assembly 302, such as the shutter assembly 200 of FIG. 2, controlled by an actuator 303. Each pixel also includes an aperture layer 322 that includes apertures 324.

The control matrix 300 may be fabricated as a diffused or thin-film-deposited electrical circuit on the surface of a substrate 304 on which the shutter assemblies 302 are formed. The control matrix 300 may include a scan-line interconnect 306 for each row of pixels 301 in the control matrix 300 and a data-interconnect 308 for each column of pixels 301 in the control matrix 300. Each scan-line interconnect 306 electrically connects a write-enabling voltage source 307 to the pixels 301 in a corresponding row of pixels 301. Each data interconnect 308 electrically connects a data voltage source, (“Vd source”) 309 to the pixels 301 in a corresponding column of pixels 301. In control matrix 300, the data voltage V_{d} provides the majority of the energy necessary for actuation of the shutter assemblies 302. Thus, the data voltage source 309 also serves as an actuation voltage source.

Referring to FIGS. 3A and 3B, for each pixel 301 or for each shutter assembly 302 in the array of pixels 320, the control matrix 300 includes a transistor 310 and a capacitor 312. The gate of each transistor 310 is electrically connected to the scan-line interconnect 306 of the row in the array 320 in which the pixel 301 is located. The source of each transistor 310 is electrically connected to its corresponding data interconnect 308. The actuators 303 of each shutter assembly 302 include two electrodes. The drain of each transistor 310 is electrically connected in parallel to one electrode of the corresponding capacitor 312 and to one of the electrodes of the corresponding actuator 303. The other electrode of the capacitor 312 and the other electrode of the actuator 303 in shutter assembly 302 are connected to a common or ground potential. In alternate implementations, the transistors 310 can be replaced with semiconductor diodes and or metal-insulator-metal sandwich type switching elements.

In operation, to form an image, the control matrix 300 write-enables each row in the array 320 in a sequence by applying V_{we} to each scan-line interconnect 306 in turn. For a write-enabled row, the application of V_{we} to the gates of the transistors 310 of the pixels 301 in the row allows the flow of current through the data interconnects 308 through the transistors 310 to apply a potential to the actuator 303 of the shutter assembly 302. While the row is write-enabled, data voltages V_{d} are selectively applied to the data interconnects 308. In implementations providing analog gray scale, the data voltage applied to each data interconnect 308 is varied in relation to the desired brightness of the pixel 301 located at the intersection of the write-enabled scan-line interconnect 306 and the data interconnect 308. In implementations providing digital control schemes, the data voltage is selected to be either a relatively low magnitude voltage (i.e., a voltage near ground) or to meet or exceed Vₐₜ (the actuation threshold voltage). In response to the application of Vₐₜ to a data interconnect 308, the actuator 303 in the corresponding shutter assembly 302 actuates, opening the shutter in that shutter assembly 302. The voltage applied to the data interconnect 308 remains stored in the capacitor 312 of the pixel 301 even after the control matrix 300 ceases to apply V_{we} to a row. It is not necessary, therefore, to wait and hold the voltage V_{we} on a row for times long enough for the shutter assembly 302 to actuate; such actuation can proceed after the write-enabling voltage has been removed from the row. The capacitors 312 also function as memory elements within the array 320, storing actuation instructions for periods as long as is necessary for the illumination of an image frame.

The pixels 301 as well as the control matrix 300 of the array 320 are formed on a substrate 304. The array includes an aperture layer 322, disposed on the substrate 304, which includes a set of apertures 324 for respective pixels 301 in the array 320. The apertures 324 are aligned with the shutter assemblies 302 in each pixel. In one implementation the substrate 304 is made of a transparent material, such as glass or plastic. In another implementation the substrate 304 is made of an opaque material, but in which holes are etched to form the apertures 324.

Components of shutter assemblies 302 are processed either at the same time as the control matrix 300 or in subsequent processing steps on the same substrate. The electrical components in control matrix 300 are fabricated using many thin film techniques in common with the manufacture of thin film transistor arrays for liquid crystal displays. Available techniques are described in Den Boer, Active Matrix Liquid Crystal Displays (Elsevier, Amsterdam, 2005), the entirety of which is incorporated herein by reference. The shutter assemblies are fabricated using techniques similar to the art of micromachining or from the manufacture of micromechanical (i.e., MEMS) devices. For instance, the shutter assembly 302 can be formed from thin films of amorphous silicon, deposited by a chemical vapor deposition process.

The shutter assembly 302 together with the actuator 303 can be made bi-stable. That is, the shutters can exist in at least two equilibrium positions (e.g. open or closed) with little or no power required to hold them in either position. More particularly, the shutter assembly 302 can be mechanically bi-stable. Once the shutter of the shutter assembly 302 is set in position, no electrical energy or holding voltage is required to maintain that position. The mechanical stresses on the physical elements of the shutter assembly 302 can hold the shutter in place.

The shutter assembly 302 together with the actuator 303 can also be made electrically bi-stable. In an electrically bi-stable shutter assembly, there exists a range of voltages below the actuation voltage of the shutter assembly, which if applied to a closed actuator (with the shutter being either open or closed), holds the actuator closed and the shutter in position, even if an opposing force is exerted on the shutter. The opposing force may be exerted by a spring such as spring 207 in shutter-based light modulator 200, or the opposing force may be exerted by an opposing actuator, such as an “open” or “closed” actuator.

The light modulator array 320 is depicted as having a single MEMS light modulator per pixel. Other implementations are possible in which multiple MEMS light modulators are provided in each pixel, thereby providing the possibility of more than just binary “on” or “off” optical states in each pixel. Certain forms of coded area division gray scale are possible where multiple MEMS light modulators in the pixel are provided, and where apertures 324, which are associated with each of the light modulators, have unequal areas.

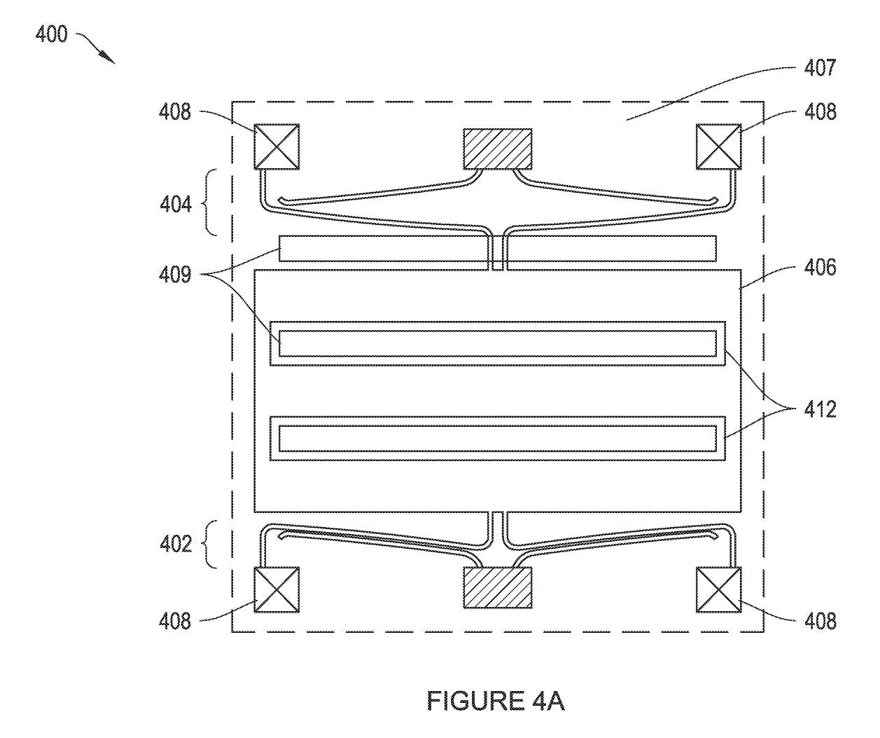

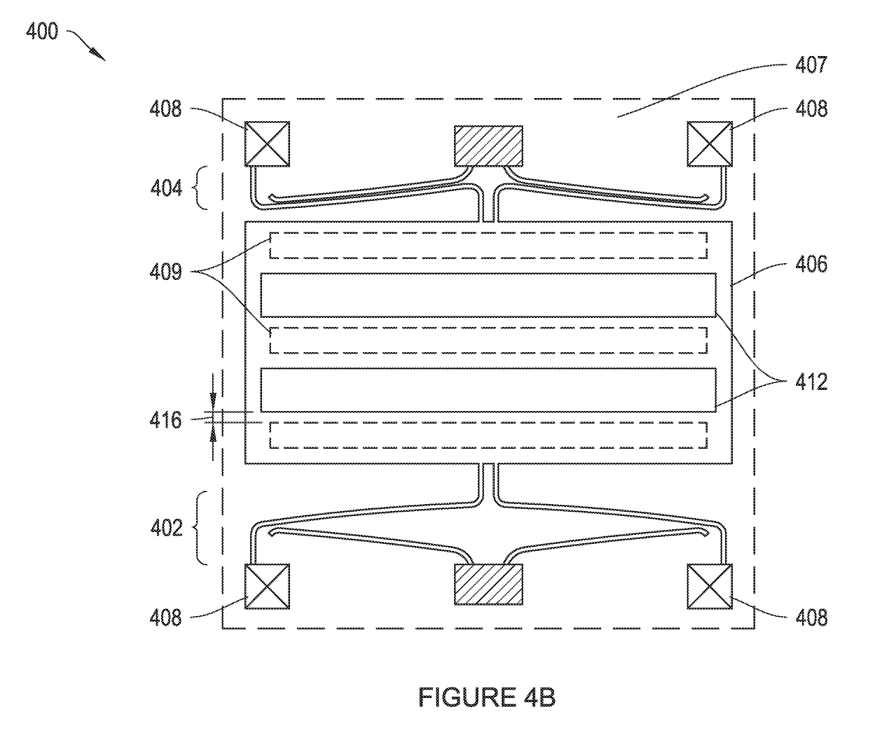

In other implementations, the roller-based light modulator 220, the light tap 250, or the electrowetting-based light modulation array 270, as well as other MEMS-based light modulators, can be substituted for the shutter assembly 302 within the light modulator array 320. FIGS. 4A and 4B illustrate an alternative shutter-based light modulator (shutter assembly) 400 suitable for inclusion in various implementations. The light modulator 400 is an example of a dual actuator shutter assembly, and is shown in FIG. 4A in an open state. FIG. 4B is a view of the dual actuator shutter assembly 400 in a closed state. In contrast to the shutter assembly 200, shutter assembly 400 includes actuators 402 and 404 on either side of a shutter 406. Each actuator 402 and 404 is independently controlled. A first actuator, a shutter-open actuator 402, serves to open the shutter 406. A second opposing actuator, the shutter-close actuator 404, serves to close the shutter 406. Both actuators 402 and 404 are compliant beam electrode actuators. The actuators 402 and 404 open and close the shutter 406 by driving the shutter 406 substantially in a plane parallel to an aperture layer 407 over which the shutter is suspended. The shutter 406 is suspended a short distance over the aperture layer 407 by anchors 408 attached to the actuators 402 and 404. The inclusion of supports attached to both ends of the shutter 406 along its axis of movement reduces out of plane motion of the shutter 406 and confines the motion substantially to a plane parallel to the substrate. By analogy to the control matrix 300 of FIG. 3A, a control matrix suitable for use with shutter assembly 400 might include one transistor and one capacitor for each of the opposing shutter-open and shutter-close actuators 402 and 404.

The shutter 406 includes two shutter apertures 412 through which light can pass. The aperture layer 407 includes a set of three apertures 409. In FIG. 4A, the shutter assembly 400 is in the open state and, as such, the shutter-open actuator 402 has been actuated, the shutter-close actuator 404 is in its relaxed position, and the centerlines of apertures 412 and 409 coincide. In FIG. 4B the shutter assembly 400 has been moved to the closed state and, as such, the shutter-open actuator 402 is in its relaxed position, the shutter-close actuator 404 has been actuated, and the light blocking portions of shutter 406 are now in position to block transmission of light through the apertures 409 (shown as dotted lines).

Each aperture has at least one edge around its periphery. For example, the rectangular apertures 409 have four edges. In alternative implementations in which circular, elliptical, oval, or other curved apertures are formed in the aperture layer 407, each aperture may have only a single edge. In other implementations the apertures need not be separated or disjoint in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through apertures 412 and 409 in the open state, it is advantageous to provide a width or size for shutter apertures 412 which is larger than a corresponding width or size of apertures 409 in the aperture layer 407. In order to effectively block light from escaping in the closed state, the light blocking portions of the shutter 406 may be arranged to overlap the apertures 409. FIG. 4B shows a predefined overlap 416 between the edge of light blocking portions in the shutter 406 and one edge of the aperture 409 formed in aperture layer 407.

The electrostatic actuators 402 and 404 are designed so that their voltage-displacement behavior provides a bi-stable characteristic to the shutter assembly 400. For each of the shutter-open and shutter-close actuators there exists a range of voltages below the actuation voltage, which if applied while that actuator is in the closed state (with the shutter being either open or closed), will hold the actuator closed and the shutter in position, even after an actuation voltage is applied to the opposing actuator. The minimum voltage needed to maintain a shutter's position against such an opposing force is referred to as a maintenance voltage Vₘ.

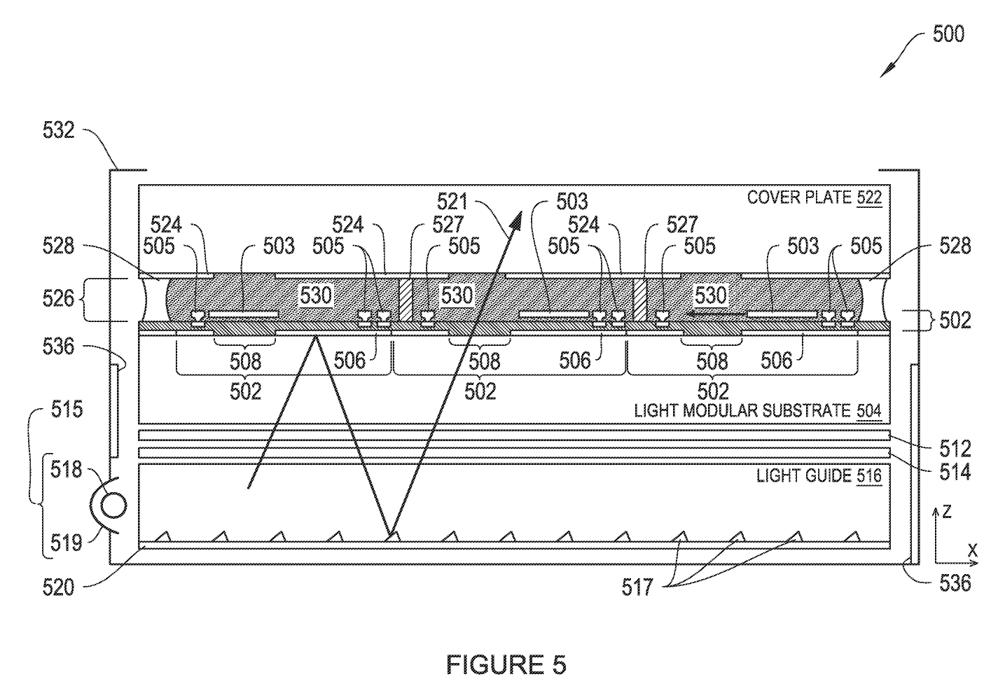

FIG. 5 is a cross sectional view of a display apparatus 500 incorporating shutter-based light modulators (shutter assemblies) 502. Each shutter assembly incorporates a shutter 503 and an anchor 505. Not shown are the compliant beam actuators which, when connected between the anchors 505 and the shutters 503, help to suspend the shutters a short distance above the surface. The shutter assemblies 502 are disposed on a transparent substrate 504, and may be made of plastic or glass. A rear-facing reflective layer, reflective film 506, disposed on the substrate 504 defines a plurality of surface apertures 508 located beneath the closed positions of the shutters 503 of the shutter assemblies 502. The reflective film 506 reflects light not passing through the surface apertures 508 back towards the rear of the display apparatus 500. The reflective aperture layer 506 can be a fine-grained metal film without inclusions formed in thin film fashion by a number of vapor deposition techniques including sputtering, evaporation, ion plating, laser ablation, or chemical vapor deposition. In another implementation, the rear-facing reflective layer 506 can be formed from a mirror, such as a dielectric mirror. A dielectric mirror is fabricated as a stack of dielectric thin films which alternate between materials of high and low refractive index. The vertical gap which separates the shutters 503 from the reflective film 506, within which the shutter is free to move, is in the range of 0.5 to 10 microns. The magnitude of the vertical gap may be less than the lateral overlap between the edge of shutters 503 and the edge of apertures 508 in the closed state, such as the overlap 416 shown in FIG. 4B.

The display apparatus 500 includes an optional diffuser 512 and/or an optional brightness enhancing film 514 which separate the substrate 504 from a planar light guide 516. The light guide includes a transparent, i.e. glass or plastic material. The light guide 516 is illuminated by one or more light sources 518, forming a backlight. The light sources 518 can be, for example, and without limitation, incandescent lamps, fluorescent lamps, lasers, or light emitting diodes (LEDs). A reflector 519 helps direct light from lamp 518 towards the light guide 516. A front-facing reflective film 520 is disposed behind the backlight 516, reflecting light towards the shutter assemblies 502. Light rays such as ray 521 from the backlight that do not pass through one of the shutter assemblies 502 will be returned to the backlight and reflected again from the film 520. In this fashion light that fails to leave the display to form an image on the first pass can be recycled and made available for transmission through other open apertures in the array of shutter assemblies 502. Such light recycling has been shown to increase the illumination efficiency of the display.

The light guide 516 includes a set of geometric light redirectors or prisms 517 which re-direct light from the lamps 518 towards the apertures 508 and hence toward the front of the display. The light re-directors can be molded into the plastic body of light guide 516 with shapes that can be alternately triangular, trapezoidal, or curved in cross section. The density of the prisms 517 generally increases with distance from the lamp 518.

In alternate implementations, the aperture layer 506 can be made of a light absorbing material, and in alternate implementations the surfaces of shutter 503 can be coated with either a light absorbing or a light reflecting material. In alternate implementations the aperture layer 506 can be deposited directly on the surface of the light guide 516. In alternate implementations the aperture layer 506 need not be disposed on the same substrate as the shutters 503 and anchors 505 (see the MEMS-down configuration described below).

In one implementation the light sources 518 can include lamps of different colors, for instance, the colors red, green, and blue. A color image can be formed by sequentially illuminating images with lamps of different colors at a rate sufficient for the human brain to average the different colored images into a single multi-color image. The various color-specific images are formed using the array of shutter assemblies 502. In another implementation, the light source 518 includes lamps having more than three different colors. For example, the light source 518 may have red, green, blue and white lamps or red, green, blue, and yellow lamps.

A cover plate 522 forms the front of the display apparatus 500. The rear side of the cover plate 522 can be covered with a black matrix 524 to increase contrast. In alternate implementations the cover plate includes color filters, for instance distinct red, green, and blue filters corresponding to different ones of the shutter assemblies 502. The cover plate 522 is supported a predetermined distance away from the shutter assemblies 502 forming a gap 526. The gap 526 is maintained by mechanical supports or spacers 527 and/or by an adhesive seal 528 attaching the cover plate 522 to the substrate 504.

The adhesive seal 528 seals in a working fluid 530. The working fluid 530 is engineered with viscosities that may be below about 10 centipoise and with relative dielectric constant that may be above about 2.0, and dielectric breakdown strengths above about 10⁴ V/cm. The working fluid 530 can also serve as a lubricant. In one implementation, the working fluid 530 is a hydrophobic liquid with a high surface wetting capability. In alternate implementations the working fluid 530 has a refractive index that is either greater than or less than that of the substrate 504.

When the MEMS-based display assembly includes a liquid for the working fluid 530, the liquid at least partially surrounds the moving parts of the MEMS-based light modulator. In order to reduce the actuation voltages, the liquid has a viscosity that may be below 70 centipoise, or even below 10 centipoise. Liquids with viscosities below 70 centipoise can include materials with low molecular weights: below 4000 grams/mole, or in some cases below 400 grams/mole. Suitable working fluids 530 include, without limitation, de-ionized water, methanol, ethanol and other alcohols, paraffins, olefins, ethers, silicone oils, fluorinated silicone oils, or other natural or synthetic solvents or lubricants. Useful working fluids can be polydimethylsiloxanes, such as hexamethyldisiloxane and octamethyltrisiloxane, or alkyl methyl siloxanes such as hexylpentamethyldisiloxane. Useful working fluids can be alkanes, such as octane or decane. Useful fluids can be nitroalkanes, such as nitromethane. Useful fluids can be aromatic compounds, such as toluene or diethylbenzene. Useful fluids can be ketones, such as butanone or methyl isobutyl ketone. Useful fluids can be chlorocarbons, such as chlorobenzene. Useful fluids can be chlorofluorocarbons, such as dichlorofluoroethane or chlorotrifluoroethylene. And other fluids considered for these display assemblies include butyl acetate, dimethylformamide.

For many implementations, it is advantageous to incorporate a mixture of the above fluids. For instance mixtures of alkanes or mixtures of polydimethylsiloxanes can be useful where the mixture includes molecules with a range of molecular weights. It is also possible to optimize properties by mixing fluids from different families or fluids with different properties. For instance, the surface wetting properties of a hexamethyldisiloxane and be combined with the low viscosity of butanone to create an improved fluid.

A sheet metal or molded plastic assembly bracket 532 holds the cover plate 522, the substrate 504, the backlight 516 and the other component parts together around the edges. The assembly bracket 532 is fastened with screws or indent tabs to add rigidity to the combined display apparatus 500. In some implementations, the light source 518 is molded in place by an epoxy potting compound. Reflectors 536 help return light escaping from the edges of light guide 516 back into the light guide. Not shown in FIG. 5 are electrical interconnects which provide control signals as well as power to the shutter assemblies 502 and the lamps 518.

In other implementations, the roller-based light modulator 220, the light tap 250, or the electrowetting-based light modulation array 270, as well as other MEMS-based light modulators, can be substituted for the shutter assemblies 502 within the display assembly 500.

Display apparatus 500 is referred to as the MEMS-up configuration, where the MEMS based light modulators are formed on a front surface of substrate 504, i.e. the surface that faces toward the viewer. The shutter assemblies 502 are built directly on top of the reflective aperture layer 506. In an alternate implementation, referred to as the MEMS-down configuration, the shutter assemblies are disposed on a substrate separate from the substrate on which the reflective aperture layer is formed. The substrate on which the reflective aperture layer is formed, defining a plurality of apertures, is referred to herein as the aperture plate. In the MEMS-down configuration, the substrate that carries the MEMS-based light modulators takes the place of the cover plate 522 in display apparatus 500 and is oriented such that the MEMS-based light modulators are positioned on the rear surface of the top substrate, i.e. the surface that faces away from the viewer and toward the back light 516. The MEMS-based light modulators are thereby positioned directly opposite to and across a gap from the reflective aperture layer. The gap can be maintained by a series of spacer posts connecting the aperture plate and the substrate on which the MEMS modulators are formed. In some implementations, the spacers are disposed within or between each pixel in the array. The gap or distance that separates the MEMS light modulators from their corresponding apertures may be less than 10 microns, or a distance that is less than the overlap between shutters and apertures, such as overlap 416.

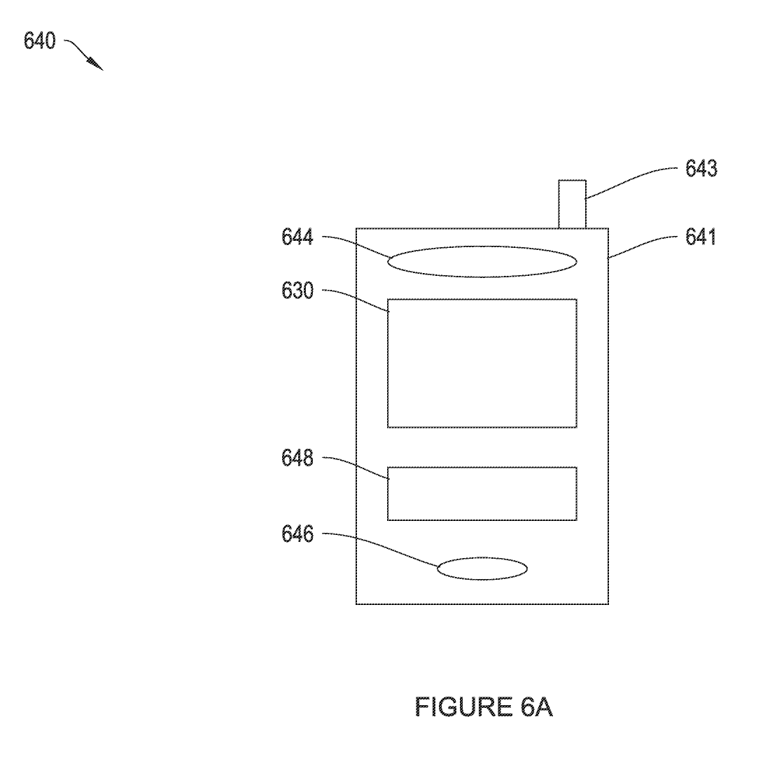

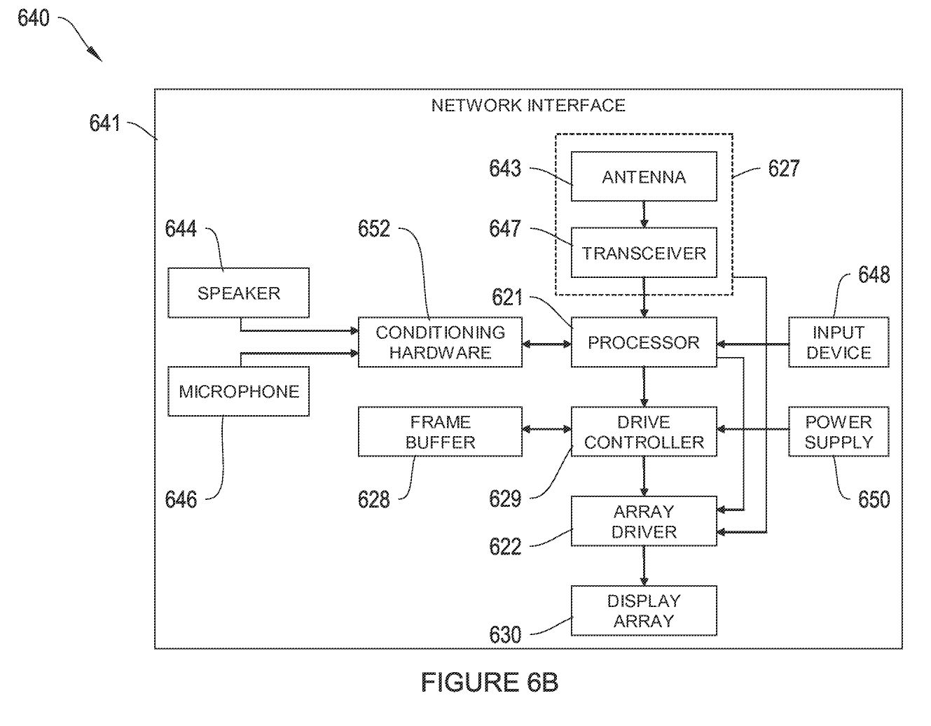

FIGS. 6A and 6B are system block diagrams illustrating a display device 640 that includes a plurality of light modulator display elements. The display device 640 can be, for example, a smart phone, a cellular or mobile telephone. However, the same components of the display device 640 or slight variations thereof are also illustrative of various types of display devices such as televisions, computers, tablets, e-readers, hand-held devices and portable media devices.

The display device 640 includes a housing 641, a display 630, an antenna 643, a speaker 645, an input device 648 and a microphone 646. The housing 641 can be formed from any of a variety of manufacturing processes, including injection molding, and vacuum forming. In addition, the housing 641 may be made from any of a variety of materials, including, but not limited to: plastic, metal, glass, rubber and ceramic, or a combination thereof. The housing 641 can include removable portions (not shown) that may be interchanged with other removable portions of different color, or containing different logos, pictures, or symbols.

The display 640 may be any of a variety of displays, including a bi-stable or analog display, as described herein. The display 630 also can be configured to include a flat-panel display, such as plasma, EL, OLED, STN LCD, or TFT LCD, or a non-flat-panel display, such as a CRT or other tube device. In addition, the display 630 can include an light modulator-based display, as described herein.

The components of the display device 640 are schematically illustrated in FIG. 6A. The display device 640 includes a housing 641 and can include additional components at least partially enclosed therein. For example, the display device 640 includes a network interface 627 that includes an antenna 643 which can be coupled to a transceiver 647. The network interface 627 may be a source for image data that could be displayed on the display device 640. Accordingly, the network interface 627 is one example of an image source module, but the processor 621 and the input device 648 also may serve as an image source module. The transceiver 647 is connected to a processor 621, which is connected to conditioning hardware 652. The conditioning hardware 652 may be configured to condition a signal (such as filter or otherwise manipulate a signal). The conditioning hardware 652 can be connected to a speaker 645 and a microphone 646. The processor 621 also can be connected to an input device 648 and a driver controller 629. The driver controller 629 can be coupled to a frame buffer 628, and to an array driver 622, which in turn can be coupled to a display array 630. One or more elements in the display device 640, including elements not specifically depicted in FIG. 6A, can be configured to function as a memory device and be configured to communicate with the processor 621. In some implementations, a power supply 650 can provide power to substantially all components in the particular display device 640 design.

The network interface 627 includes the antenna 643 and the transceiver 647 so that the display device 640 can communicate with one or more devices over a network. The network interface 627 also may have some processing capabilities to relieve, for example, data processing requirements of the processor 621. The antenna 643 can transmit and receive signals. In some implementations, the antenna 643 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 643 transmits and receives RF signals according to the Bluetooth® standard. In the case of a cellular telephone, the antenna 643 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 647 can pre-process the signals received from the antenna 643 so that they may be received by and further manipulated by the processor 621. The transceiver 647 also can process signals received from the processor 621 so that they may be transmitted from the display device 640 via the antenna 643.

In some implementations, the transceiver 647 can be replaced by a receiver. In addition, in some implementations, the network interface 627 can be replaced by an image source, which can store or generate image data to be sent to the processor 621. The processor 621 can control the overall operation of the display device 640. The processor 621 receives data, such as compressed image data from the network interface 627 or an image source, and processes the data into raw image data or into a format that can be readily processed into raw image data. The processor 621 can send the processed data to the driver controller 629 or to the frame buffer 628 for storage. Raw data typically refers to information that identifies the image characteristics at each location within an image. For example, such image characteristics can include color, saturation and gray-scale level.

The processor 621 can include a microcontroller, CPU, or logic unit to control operation of the display device 640. The conditioning hardware 652 may include amplifiers and filters for transmitting signals to the speaker 645, and for receiving signals from the microphone 646. The conditioning hardware 652 may be discrete components within the display device 640, or may be incorporated within the processor 621 or other components.

The driver controller 629 can take the raw image data generated by the processor 621 either directly from the processor 621 or from the frame buffer 628 and can re-format the raw image data appropriately for high speed transmission to the array driver 622. In some implementations, the driver controller 629 can re-format the raw image data into a data flow having a raster-like format, such that it has a time order suitable for scanning across the display array 630. Then the driver controller 629 sends the formatted information to the array driver 622. Although a driver controller 629, such as an LCD controller, is often associated with the system processor 621 as a stand-alone Integrated Circuit (IC), such controllers may be implemented in many ways. For example, controllers may be embedded in the processor 621 as hardware, embedded in the processor 621 as software, or fully integrated in hardware with the array driver 622.

The array driver 622 can receive the formatted information from the driver controller 629 and can re-format the video data into a parallel set of waveforms that are applied many times per second to the hundreds, and sometimes thousands (or more), of leads coming from the display's x-y matrix of display elements.

In some implementations, the driver controller 629, the array driver 622, and the display array 630 are appropriate for any of the types of displays described herein. For example, the driver controller 629 can be a conventional display controller or a bi-stable display controller (such as a light modulator display element controller). Additionally, the array driver 622 can be a conventional driver or a bi-stable display driver (such as a light modulator display element driver). Moreover, the display array 630 can be a conventional display array or a bi-stable display array (such as a display including an array of light modulator display elements). In some implementations, the driver controller 629 can be integrated with the array driver 622. Such an implementation can be useful in highly integrated systems, for example, mobile phones, portable-electronic devices, watches or small-area displays.

In some implementations, the input device 648 can be configured to allow, for example, a user to control the operation of the display device 640. The input device 648 can include a keypad, such as a QWERTY keyboard or a telephone keypad, a button, a switch, a rocker, a touch-sensitive screen, a touch-sensitive screen integrated with the display array 630, or a pressure- or heat-sensitive membrane. The microphone 646 can be configured as an input device for the display device 640. In some implementations, voice commands through the microphone 646 can be used for controlling operations of the display device 640.

The power supply 650 can include a variety of energy storage devices. For example, the power supply 650 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 650 also can be a renewable energy source, a capacitor, or a solar cell, including a plastic solar cell or solar-cell paint. The power supply 650 also can be configured to receive power from a wall outlet.

In some implementations, control programmability resides in the driver controller 629 which can be located in several places in the electronic display system. In some other implementations, control programmability resides in the array driver 622. The above-described optimization may be implemented in any number of hardware and/or software components and in various configurations.

The display device 640 can be, for example, a smart phone, a cellular or mobile telephone. However, the same components of the display device 640 or slight variations thereof are also illustrative of various types of display devices such as televisions, computers, tablets, e-readers, hand-held devices and portable media devices.

Systems are methods are provided for fabricating devices, including micromechanical devices, from conventional glass-based display fabrication processes. Also provided herein are devices having a capacitive element, formed from conventional glass-based display fabrication processes. According to various implementations, the devices can include MicroElectroMechanical System (MEMS) shutter displays that also have additional components, such as accelerometers, gyroscopes, speakers and microphones, on the display substrate. This allows for integration of such components onto the MEMS shutter display.

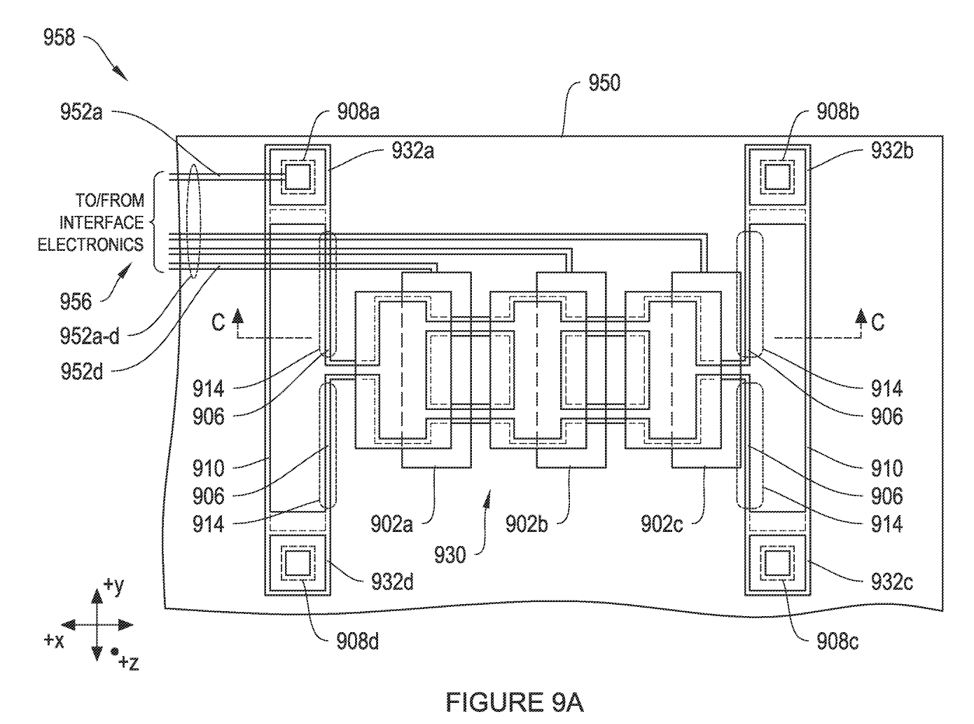

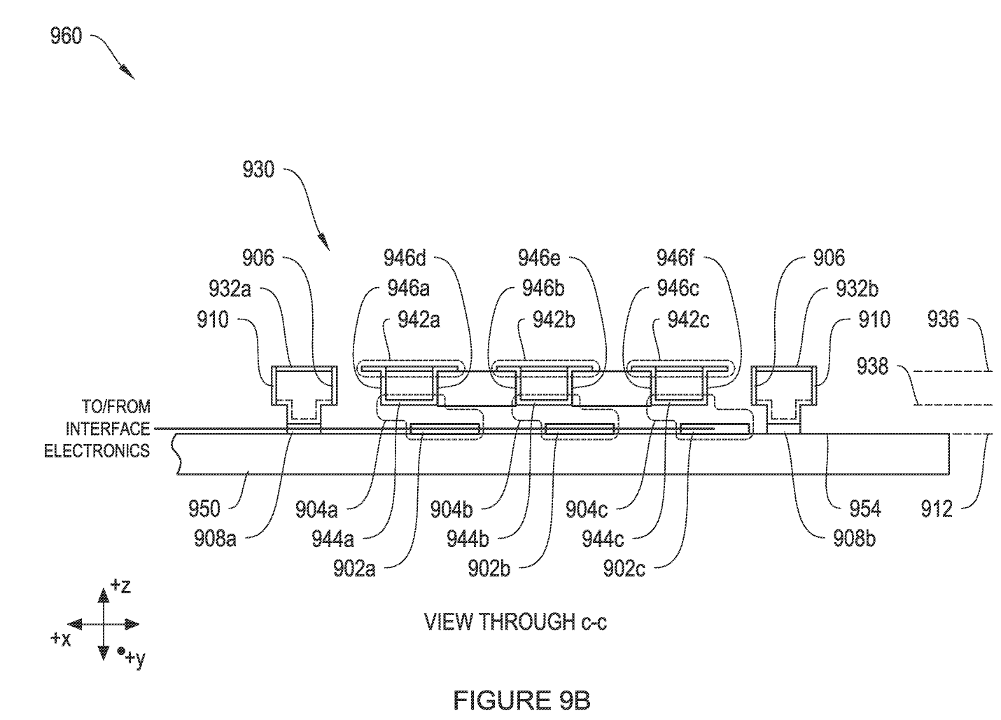

The fabrication methods use large critical dimension lithography on large area substrates such as those used in inexpensive LCD manufacturing. Large critical dimension lithography includes, for example, critical dimensions larger than about 1 micron. The manufactured devices include MEMS devices that have capacitive elements formed above a movable shuttle, MEMS devices that have capacitive elements formed below a movable shuttle, and MEMS devices that have capacitive elements formed adjacent to a movable shuttle. In some implementations, the capacitive elements may form a differential capacitor, which may be less sensitive to noise. As discussed in greater detail below, FIGS. 9A and 9B below show a top view and cross-sectional view, respectively, of an exemplary MEMS sensor structure (an accelerometer 958) including electrodes on the substrate to provide capacitive ability.

According to various implementations, the systems and methods disclosed herein allow for the formation of a variety of micromechanical actuators and sensors that include a corrugated structure, such as a shuttle. Systems and methods are provided for glass-based display fabrication platforms including micromechanical structures that are smaller than structures that can be produced using conventional methods and designs.

A corrugated structure includes one or more sidewall beams, which are elements characterized by high height-to-width aspect ratios. Sidewall beams are also used as tethers for supporting corrugated structures, such as shuttles, above underlying substrates. In many applications, a corrugated structure, as compared to a conventional flat, rigid plate, has at least one of higher strength, greater stiffness, greater structural integrity, greater reliability, and lower thermal sensitivity. In some applications, a corrugated structure enables formation of multiple capacitors for sensing the position of the structure or inducing its motion.

According to certain implementations, the use of conventional glass-based display fabrication technology to fabricate microsystems facilitates the monolithic integration of displays, sensors, actuators, and interface circuitry. As a result, implementations can be used for the development of fully integrated systems that include components such as displays, accelerometers, gyroscopes, microphones, speakers, pressure sensors, energy scavenging devices, mechanical resonators, or any combination thereof. Accelerometers may be used, for example, for gesture recognition or tilt-sensing.

Some examples of actuators and sensors include corrugated structures are described in detail herein, and alternative implementations of actuators and sensors may also include corrugated structures as described herein. Some implementations include one or more actuators such as, without limitation, speakers, mechanical resonators, optical modulators, and spatial light modulators. Some implementations include one or more sensors that provide output signals based on an environmental stimulus such as, without limitation, pressure, acoustic energy, thermal energy, the presence of a chemical, and nuclear energy.

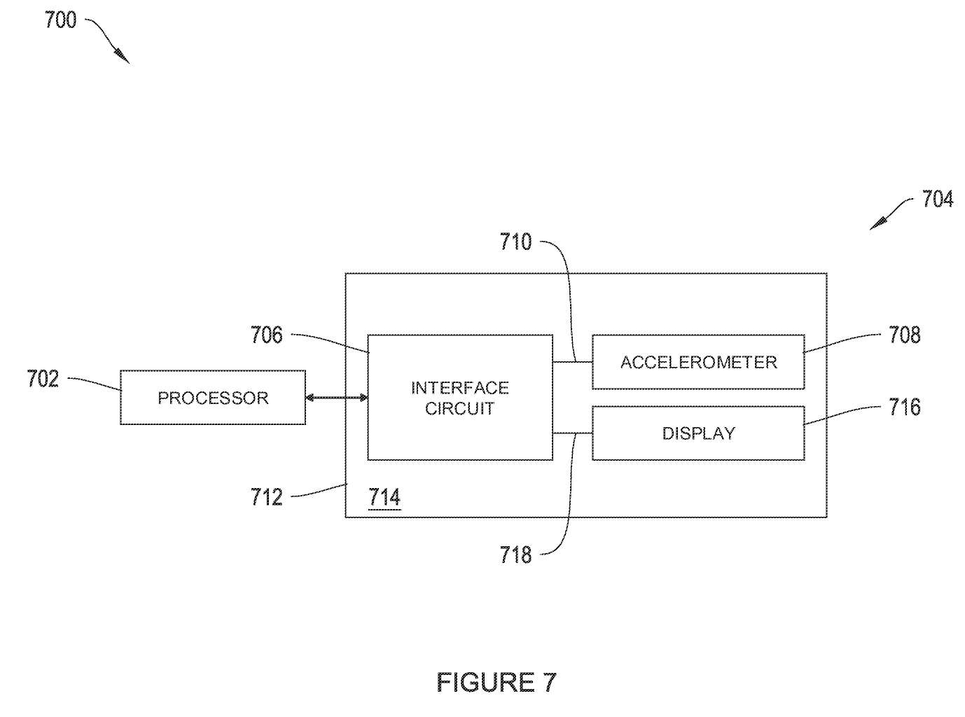

FIG. 7 depicts an example of a micromechanical system. The system 700 includes a processor 702 and a micromechanical module 704. The processor 702 is a general purpose processor that receives signals from and transmits signals to the micromechanical module 704, executes computer programs, and stores information in memory. The micromechanical module 704 is a transducer module that includes a display and a sensor for providing an electrical signal based on acceleration of the module. The micromechanical module 704 includes an interface circuit 706, an accelerometer 708, and a display 716. The interface circuit 706, accelerometer 708, and display 716 are monolithically integrated on the surface 714 of a common substrate 712. Although the illustrative example includes an accelerometer 708, other types of micromechanical sensors or actuators may be used in the micromechanical module 704. In some implementations, the micromechanical module 704 does not include a display 716.

The interface circuit 706 includes control electronics for providing bias signals to the accelerometer 708 and amplifying and conditioning output signals from the accelerometer 708. The interface circuit 706 also includes a control matrix for controlling display elements of display 716. The interface circuit 706 and the accelerometer 708 are electrically coupled via interconnects 710. The interface circuit 706 provides the conditioned output signals to the processor 702.

The accelerometer 708 provides an output signal, based on an acceleration of an integrated proof mass. The accelerometer 708 provides the output signal to the interface circuit 706 on the interconnects 710. The accelerometer 708 is described in more detail below, with respect to FIGS. 9A and 9B.

The display 716 is a MEMS-shutter-based display, which is electrically coupled with the control circuit 706 via the interconnects 718. Examples of MEMS-shutter-based displays and methods for their fabrication are described above, and in U.S. patent application Ser. No. 12/483,062, which is incorporated herein, in its entirety, by reference. In some implementations, the display 716 is a non-MEMS-shutter-based display. Displays which may be used for the display 716 include, without limitation, thin-film liquid-crystal-displays, and organic light emitting diode-based displays.

In some implementations, the system 700 includes a micromechanical module 704 that includes more than one micromechanical device. In certain implementations, the micromechanical module 704 includes one or more sensors, one or more actuators, or any combination of sensors and actuators.

### Sidewall Beams

The sidewall beam structure referred to herein is, in one implementation, a beam formed from a layer of structural material. A sidewall beam is formed by operations that include conformally depositing structural material over a removable mold disposed on a substrate, wherein the mold includes horizontal surfaces and one or more vertical surfaces, selectively removing the structural material from horizontal surfaces of the mold (such as by way of a directional etch), and removing the mold. A sidewall beam has a horizontal dimension that is substantially equal to the thickness of a structural layer material as deposited on a vertical sidewall beam of a removable mold. The sidewall beam is separated from a substrate by a gap after removal of the mold. A sidewall beam is typically characterized by a height-to-width aspect ratio greater than one, wherein height is the dimension of the beam in the vertical direction and width is the narrower of the dimensions of the beam in the horizontal direction. In some implementations, the sidewall beam has a height-to-width aspect ratio greater than two, or a height-to-width aspect ratio greater than four.

As used herein, the terms “horizontal” and “vertical” depend on the orientation of the substrate. “Horizontal” is defined as substantially parallel to the plane defined by the major dimension of the substrate, and “vertical” is defined as substantially orthogonal to the plane defined by the major dimension of the substrate.

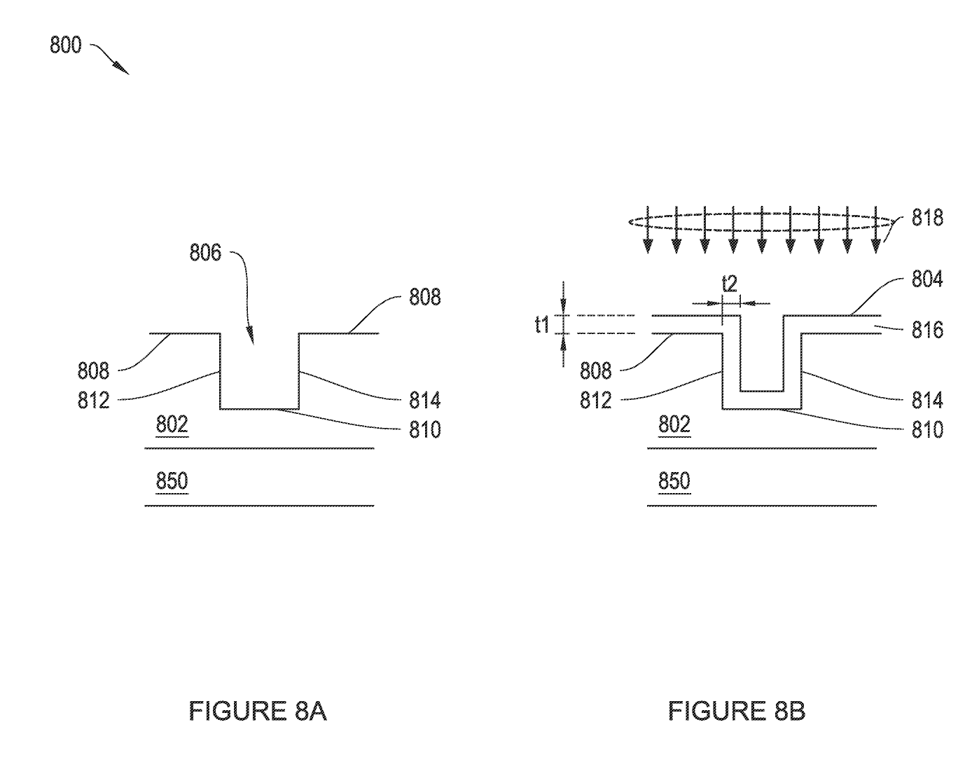

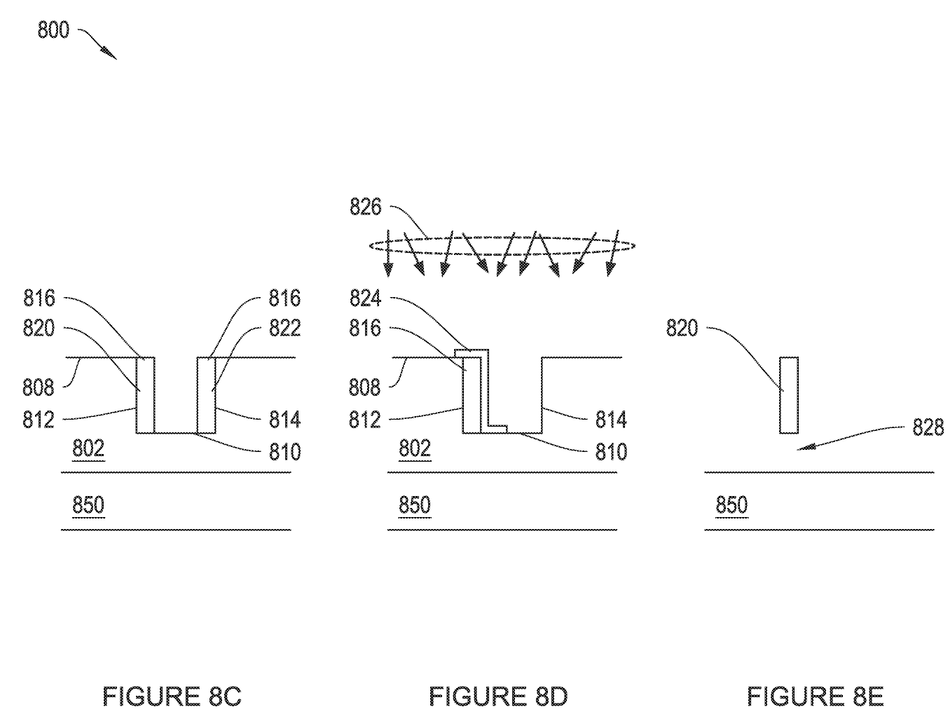

FIGS. 8A-8E depict schematic drawings of a cross-sectional view of a region of a substrate including a sidewall beam at different stages of fabrication, according to one example. FIG. 8A depicts a mold 800, which is formed by depositing sacrificial layer 802 on substrate 850 and forming feature 806 in the sacrificial layer 802. The feature 806 is a U-shaped channel that includes a horizontal top surface 808, a horizontal bottom surface 810, and vertical sidewall beams 812 and 814. The sacrificial layer 802 is a material that can be selectively removed over the structural material that composes the sidewall beam.

In various implementations, the sacrificial layer 802 has a thickness within the range of about 0.2 microns to about 5 microns, or within the range of about 0.2 microns to about 10 microns. In one implementations, the sacrificial layer 802 includes vias, each of which defines a first portion of a mold for an anchor. Vias are formed using conventional photolithographic techniques, and the vias extend down to interconnect-pads. In one application, after the formation of vias, the sacrificial layer 802 is fully hardened at an elevated temperature so that it is no longer photolithographically patterned. In some implementations, a second sacrificial layer is formed on the sacrificial layer 802, to allow for the formation of additional features such as anchors, tethers, shuttles, and sidewall beams.

In one application, a photo-definable polyimide is used as the material for the sacrificial layer 802 because it can be easily patterned using conventional photolithographic techniques. Further, it can be readily removed during a release etch using a conventional plasma etch or non-directional reactive-ion etch. In other applications, other materials may be used for the sacrificial layer 802, such as phenol-formaldehyde resins, polymers, photoresists, non-photo-definable polyimides, glasses, semiconductors, metals, and dielectrics. In one example, the material used for the sacrificial layer 802 is a phenol-formaldehyde resins with a formaldehyde to phenol molar ratio of less than one, such as a Novolac resin. The choice of the material for the sacrificial layer 802 may be based on many considerations, such as its etch selectivity over other materials in the overall structure, its ability to maintain its shape at elevated temperatures, the relative ease with which it can be shaped and/or patterned, process thermal budget, deposition temperature, and the choice of structural material used for elements within the complete device.

FIG. 8B depicts the region of the mold 800 after the deposition of the structural layer 804 on the mold 800. The structural layer 804 includes a structural material 816. The structural layer 804 is deposited such that it is conformal with the underlying sacrificial layer 802 and the U-shaped feature 806. As a result, the structural material 816 is disposed as a continuous layer that includes horizontal portions disposed on each of the top surfaces 808 and the bottom surface 810, and vertical portions disposed on the sidewall beams 812 and 814. The as-deposited layer thickness of the horizontal portions of the structural layer 804 (i.e., the thickness of the structural material 816 disposed on each of the top surface 808 and the bottom surface 810) is equal to thickness t1, while the as-deposited layer thickness of the vertical portions of the structural layer 804 (i.e., the thickness of the structural material 816 disposed on each of the sidewall beams 812 and 814) is equal to the thickness t2.

In one example, the structural layer 804 is a layer of amorphous silicon having a thickness of approximately 0.4 micron and is substantially uniform on all exposed surfaces (i.e., each of t1 and t2 is substantially equal to 0.4 micron). In other examples, the thickness of the structural layer 804 is within the range of approximately 0.01 micron to 5 microns. In some examples, t1 and t2 are not the same. The thickness of structural layer 804 influences the reliability and performance (for example, resiliency, sensitivity, and stiffness) of the structure it is used in. Thus, for example, the thickness of the structural layer 804 may be based on the desired mechanical behavior of a shuttle and tethers. In various implementations, the structural layer 804 may have any thickness. Additionally, in some implementations, the structural layer 804 may be comprised of any suitable material, such as polysilicon, silicon carbide, dielectrics, metals, glasses, ceramics, dielectrics, germanium, III-V semiconductors, and II-VI semiconductors.

The structural layer 804 is deposited such that it is conformal with the mold formed by the underlying sacrificial layer 802. The deposition of the structural layer 804 results in the formation of vertical elements, which are nascent sidewall beams 812 and 814.

A first layer is substantially conformal with an underlying second layer when it is disposed as a continuous layer on the exposed surfaces of a second layer such that the first layer and second layer have substantially the same shape. In some implementations, the as-deposited layer thickness of the first layer is substantially uniform on all of the surfaces of the second layer on which it is deposited (i.e., t1 and t2 are substantially equal). Uniformity of the as-deposited layer thickness can be affected by, for example, choice of deposition method, precursor gasses, and deposition conditions. As a result, a substantially conformal layer can have some variation in its thickness between portions of the layer disposed on horizontal surfaces and portions of the layer disposed on substantially vertical surfaces. The variation is typically within one order of magnitude (i.e., t1≦10*t2).

After its deposition, the layer 804 is etched in an etch 818. The etch 818 is a highly directional etch that removes structural material from exposed horizontal surfaces but does not appreciably affect structural material disposed on vertical surfaces. Therefore, the etch 818 removes structural material 816 from the top surface 808 and the bottom surface 810 but not the sidewall beams 812 and 814. In some implementations, etchants used in directional etching may include a plasma of reactive gases such as fluorocarbons, oxygen, chlorine, and/or boron trichloride. In some applications, other gases may be added to the plasma or reactive gases, such as nitrogen, argon, and/or helium.

FIG. 8C depicts the region of the mold 800 after the etch 818. After the etch 818, the structural material 816 remains on the sidewall beams 812 and 814. The structural material 816 on the sidewall beam 812 represents a first nascent sidewall beam 820. Similarly, the structural material 816 on the sidewall beam 814 represents a second nascent sidewall beam 822. In some implementations, each of the first 820 and second 822 sidewall beams are design elements of a micromechanical device. In such implementations, the mold 800 can be removed at this point. In some implementations, however, one of the first 820 and second 822 nascent sidewall beams is removed prior to removal of the mold 800.

FIG. 8D depicts the removal of one sidewall beam. A mask layer 824 is disposed over the structural material disposed on the sidewall beam 812 to protect the structural material from attack in the etch 826. The etch 826 is a non-directional etch suitable for removing exposed structural material. Thus, the etch 826 removes structural material from exposed surfaces without regard to the orientation of the surface. As a result, the etch 826 removes structural material 816 from the sidewall beam 814. The non-directional etch may be an isotropic etchant, such as a corrosive liquid or a chemically active ionized gas, such as a plasma.

FIG. 8E depicts the fully formed and released first sidewall beam 820. After the removal of the sacrificial layer 802, the sidewall beam 820 is free from the substrate 850 and is separated from the substrate 850 by an air gap 828.

### Corrugated Structure

In some implementations, the sidewall beam is an element of a corrugated structure. A corrugated structure is a movable element having one or more sidewalls positioned at an angle to a base and coupled to the base. The coupling of the one or more sidewalls to the base limits the movement of the sidewalls. In one example, a sidewall is positioned orthogonally to the base. The corrugated structure may be shaped into folds having parallel and alternating ridges and grooves. In one example, the corrugated structure is a shuttle. In some implementations, a corrugated structure includes multiple first surfaces that are substantially coplanar in a first plane and substantially parallel to the plane of the substrate, multiple second surfaces that are substantially coplanar in a second plane and substantially parallel to the plane of the substrate, and multiple sidewall beams that are substantially coplanar in a third plane and substantially orthogonal to the plane of the substrate. Examples of corrugated structures include shuttles that are continuous as well as shuttles segmented, and thus not substantially continuous.

FIGS. 9A and 9B show a top view and cross-sectional view, respectively, of an exemplary sensor structure including electrodes 902a-902c. The electrodes 902a-902c are formed on the substrate 950, and provide capacitive ability.

According to the illustrative implantation, the sensor structure shown in FIGS. 9A and 9B is an accelerometer 958, and includes a substrate 950, a shuttle 930, capacitors 904a-904c, anchors 932a-932d, tethers 906 and 910, interconnects 952a-952d, and interconnect-pads 908a-908d. The shuttle 930 is a corrugated structure, and functions as a mass for the accelerometer 958. The shuttle 930 is movable, with respect to the substrate 950, along the x-direction.

The position of the shuttle 930 is sensed by the capacitors 904a-904c. As shown in cross section in FIG. 9B, the shuttle 930 has a top wall 942a-942c, a bottom wall 944a-944c and sidewall beams 946a-946f. The sidewall beams 946a-946f are the type of sidewalls formed by a sidewall beam process, such as described with respect to FIGS. 8A-8E. Each of the depicted sidewalls 946a-946f has a high aspect ratio, where the sidewall has one dimension, such as length, that is at least four times greater than another dimension, such as width. One electrode of the first capacitor 904a is carried on the first bottom wall 944a of the movable shuttle 930 and the other electrode 902a is formed on the surface of the substrate 950. The position of the shuttle 930 is indicated by an output signal based on the aggregate capacitance of the capacitors 904a-904c. The output signal is provided to an interface circuit 956 on interconnects 952a-952d.

The interface circuit 956 includes circuits for conditioning and amplifying output signals from the capacitors 904a-904c. In some implementations, the interface circuit 956 includes control circuits for providing voltage to one or more of the capacitors 904a-904c. Exemplary processes suitable for forming circuit elements, as well as exemplary circuits, are provided in U.S. Pat. No. 7,405,852, issued Jul. 29, 2008, which is incorporated herein by reference. Although the interface circuit 956 is located within a specifically defined region of the substrate 950, in other implementations, one or more circuit elements are disposed on the substrate 950 within or near the structure of the accelerometer 958.

The shuttle 930, the tethers 906 and 910, and the anchors 932a-932d are formed on the substrate 950. The electrodes 902a-902c are regions of electrically conductive amorphous silicon disposed on the surface 954 of the substrate 950. The interconnects 952a-952d are traces of electrically conductive amorphous silicon disposed on surface 954 of the substrate 950. The first interconnect 954a provides electrical connectivity between the shuttle 930 and the interface circuit 956. The second 952b, third 952c, and fourth 952d interconnects provide electrical connectivity between the interface circuit 956 and the electrodes 902a-902c, respectively.

Each of the interconnect-pads 908a-908d is a region of electrically conductive amorphous silicon suitable for providing electrical connectivity between the subsequently formed anchors 932a-932d and the interconnects 952a-952d. Interconnect pads 908a-908d are formed at each site where an anchor 932a-932d is to be formed to ensure that the total height above the substrate 950 of each anchor 932a-932d is substantially equal. In some implementations, an interconnect pad is not formed at the site of each anchor 932a-932d. The shuttle 930 is electrically connected to ground potential through the first interconnect 952a and the first anchor 932a.

In some implementations, one or more of the electrodes 902a-902c, the interconnects 952a-952d, and the interconnect-pads 908a-908d include an electrically conductive material other than amorphous silicon. Materials suitable for use in any of electrodes, interconnects, and interconnect-pads include, without limitation, metals, semiconductor materials, silicides, conductive polymers, metal oxides, titanium nitride, and the like.

The tethers 906 extend from anchors the 932a-932d to support the shuttle 930 above substrate 950. The tethers 906 support the shuttle 930 such that the surfaces 942a-942c and 944a-944c of the shuttle 930 are coplanar in the first plane 936 and the second plane 938, respectively. The first 936 and second 938 planes are substantially parallel with a third plane 912, which is the plane of the surface 954 of the substrate 950.

The beam portion 914 of each of the tethers 906 is a sidewall beam that is selectively resilient along the x-direction, as shown, and the tethers 906 collectively enable motion of shuttle 930 only along the x-direction. Therefore, the accelerometer 958 provides an electrical output signal that is based on accelerations imparted on a proof mass (which is the shuttle 930 in the current example) along the x-direction.

The tethers 910 are sidewall beams formed between first 932a and fourth 932d anchors, and second 932b and third 932c anchors, as part of the formation of the tethers 906. According to one implementation, the tethers 910 do not provide functionality, and the tethers 910 can be removed without affecting the accelerometer 958. By mechanically connecting each end of each of tethers 910 to an anchor 932a-932d, however, the fabrication steps required to remove tethers 910 are avoided in some implementations. However, in some implementations, the tethers 910 are removed during fabrication of the accelerometer 958. Thus, an accelerometer 958 may not include tethers.

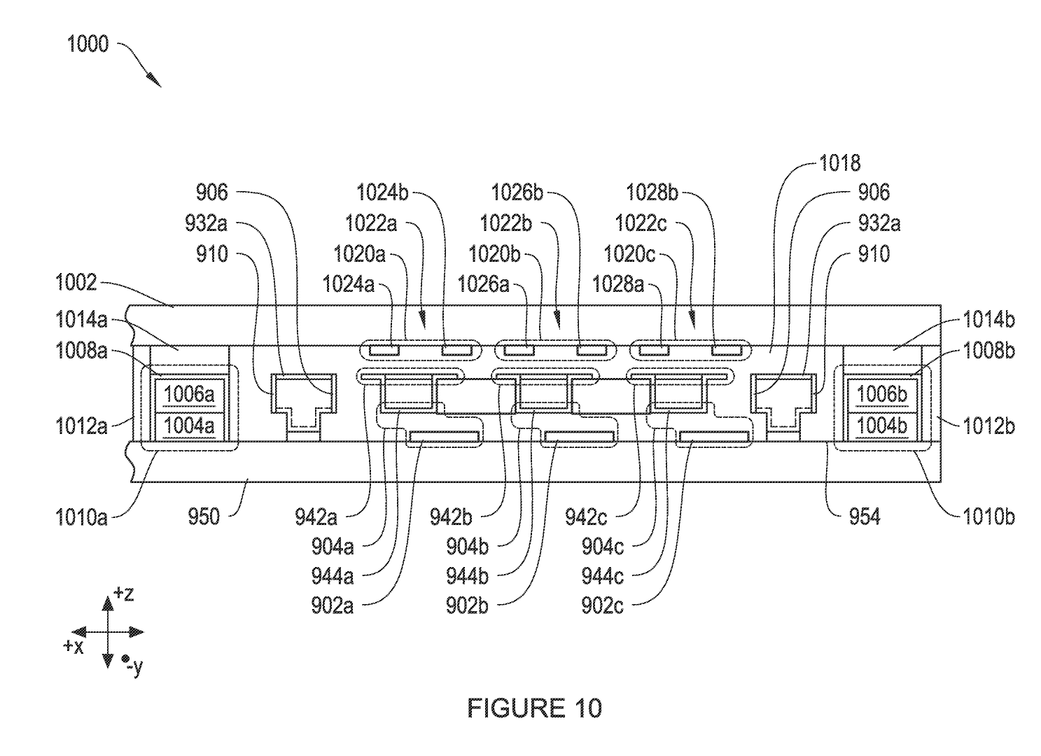

FIG. 10 shows a cross-sectional view of a sensor 1000 having a cover plate 1002, according to one example. The sensor 1000 includes the accelerometer 958 shown in FIGS. 9A and 9B, after optional formation of a chamber 1018. The cover plate 1002 can be the glass top of a display, such as a DMS display, and the accelerometer 958 can be built on the same substrate 950 as the light modulators of the display. This provides a display that is tilt sensitive. The cover plate 1002 may be substantially similar to the substrate 950. In particular, the cover plate 1002 may be formed from the same materials as the substrate 950.

According to one implementation, cover plate electrodes 1020a-1020c are formed on the surface 1016 of the cover plate 1002. Each of the cover plate electrodes 1020a-1020c has a U-shape. The cover plate electrodes 1020a-1020c are similar to the substrate electrodes 902a-902c. However, each electrode 1020a, 1020b, and 1020c includes a pair of fingers 1024a-1024b, 1026a-1026b, and 1028a-1028b, respectively, that extend past the surface 1016 of the cover plate 1002 and substantially match the shape of top surfaces 942a, 942b, and 942c of the shuttle 930. The cover plate electrodes 1020a, 1020b, and 1020c and top surfaces 942a, 942b, and 942c collectively define cover plate capacitors 1022a, 1022b, and 1022c, respectively.

Spacers 1014a and 1014b are formed on the surface 1016 of the cover plate 1002. The spacers 1014a, 1014b are an annulus of photo-definable polyimide. The spacer 1014a, 1014b match the shape of the annuli 1010a, 1010b, which is formed on surface 954 of the substrate 950 during the formation of the accelerometer 958. Each of the spacers 1014a, 1014b and the annuli 1010a, 1010b has an inner diameter sufficient to surround the shuttle 930, the tethers 906, and the anchors 932a, 932b. A structural material 1008a, 1008b protects sacrificial layers 1004a, 1004b and 1006a, 1006b from removal by a sacrificial layer etch.

In some implementations, the spacers 1014a, 1014b are each an annulus of material having a thickness equal to the desired height of chamber 1018. In such implementations, the annuli 1010a, 1010b may not be included. Materials suitable for use in the spacers 1014a, 1014b include, without limitation, polyimides, resins, polymers, Novalac resin, epoxies, and metals. In some implementations, the spacers 1014a, 1014b are disposed on the cover plate 1002 by one or more of spin-coating, evaporation, sputtering, and electroplating techniques. In some implementations, the spacers 1014a, 1014b are formed on the surface 954 of the substrate 950.

The cover plate 1002 is aligned and mated with the substrate 950. According to one implementation, after the cover plate 1002 and the substrate 950 are aligned and mated, epoxy 1012a, 1012b is applied to the outer vertical surface of the spacers 1014a, 1014b and the annul 1010a, 1010b. Epoxy 1012a, 1012b mechanically bonds the sacrificial layers 1004a, 1004b, 1006a, and 1006b, the structural layers 1008a, 1008b, the spacers 1014a, 1014b, and the annuli 1010a, 1010b together to collectively define the chamber 1018.

In some implementations, the chamber 1018 is substantially sealed and protects the accelerometer 958 from environmental effects. The chamber 1018 also enables control over the environment around the accelerometer 958. For example, in some implementations, the chamber 1018 is filled with a gas, such as an inert gas. In some implementations, the chamber 1018 is filled with a gas having a high dielectric constant to mitigate undesired electrostatic charging effects. In some implementations, a vacuum is formed within the chamber 1018 to mitigate air pressure effects on the movement of the shuttle 930. In still some other implementations, the chamber 1018 is filled with a fluid, such as an insulating, low-viscosity, high-dielectric constant lubricating fluid.

The cover plate 1002 and the spacers 1014a, 1014b are typically provided as part of a glass-based display fabrication process. Thus, these elements can be included in a micromechanical actuator or sensor with little or no additional cost.

In implementations such as that shown in FIG. 10, the cover plate 1002 includes electrodes 1020a-1020c. The fingers 1024a-1024f of each of cover plate electrode 1020a-1020c are aligned (along the x-direction) the top surfaces 942a-942c such that each of the fingers 1024a-1024f of each of cover plate electrodes 1020a-1020c overlaps approximately one-half of the available area of its respective top surface 942a-942c when the shuttle 930 is in its quiescent state. For example, the fingers 1024a and 1024d of the first cover plate electrode 1020a are aligned with the top surface 942a of the shuttle 930, such that about half of the area of the top surface 942a faces the fingers 1024a and 1024d. As a result, the capacitance changes exhibited by the capacitors 1022a-1022c increase the output signal from the accelerometer 958 thereby improving the sensitivity of the accelerometer 958.

In some implementations, the offset between the substrate electrodes 902a-902c and the bottom surfaces 944a-944c along the x-direction is exploited to allow one or more of the capacitors 904a-904c to be used as an electrostatic actuator for inducing motion of the shuttle 930. In some implementations, the offset between the cover plate electrodes 1020a-1020c and the top surfaces 942a-942c along the x-direction is exploited to allow one or more of the capacitors 1022a-1022c to be used as an electrostatic actuator for inducing motion of the shuttle 930.

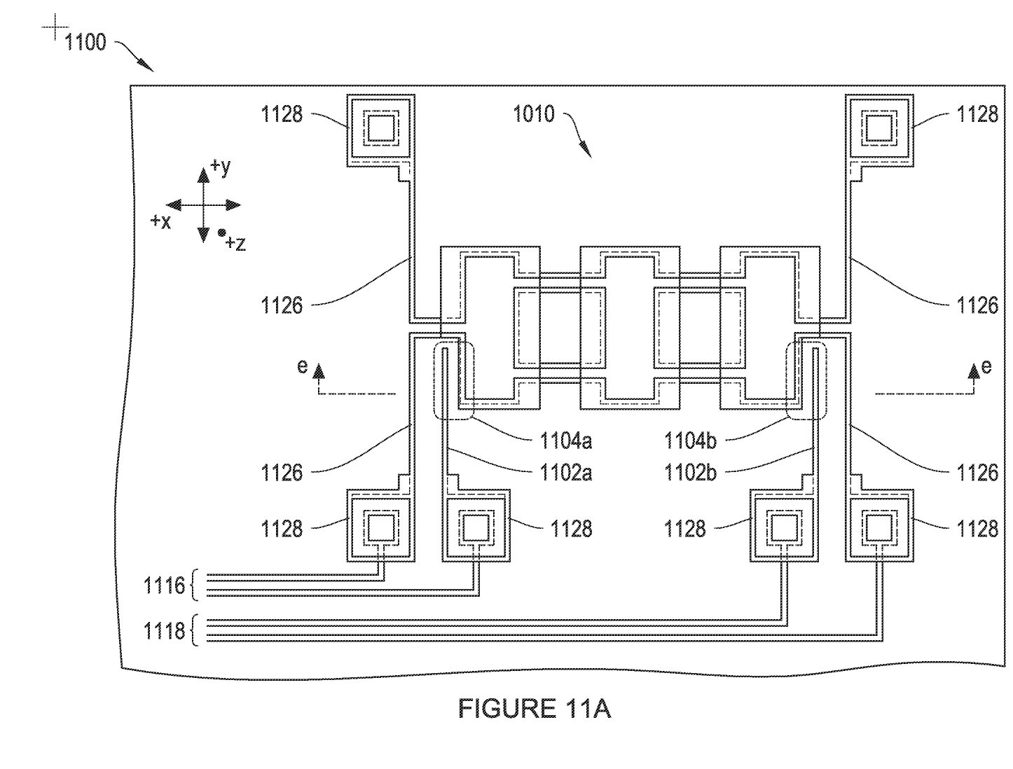

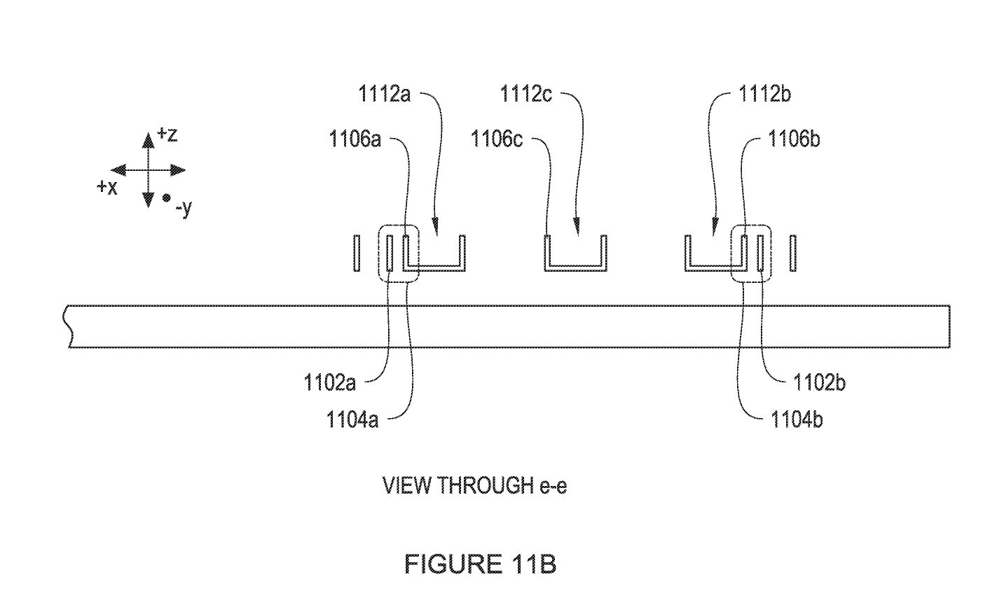

FIGS. 11A and 11B show a top view and a cross-sectional view, respectively, of an example of a sensor structure including electrodes 1102a,1102b. The cross-sectional view depicted in FIG. 11B is taken through line e-e of FIG. 11A. The sensor structure is an accelerometer 1100, and includes a shuttle 1010, tethers 1126, anchors 1128, and capacitors 1104a, 1104b. The accelerometer 1100 uses the sidewall beams 1106a, 1106b to form capacitive sensors 1104a, 1104b. The sidewall beams 1106a, 1106b have a high aspect ratio, providing, for example, a relatively small width and relatively large height. This provides at least one relatively large surface for carrying an electrode of the type that can be used in a capacitor.

The first capacitor 1104a includes a first electrode 1102a and a first sidewall beam 1106a of a first segment 1112a of the shuttle 1010. The first capacitor 1104a provides an output signal 1101 to an interface circuit. The output signal 1116 is based on the capacitance value of the first capacitor 1104a, which is based on the separation between the first electrode 1102a and the first sidewall beam 1106a. Similarly, the second capacitor 1104b includes a second electrode 1102b and a second sidewall beam 1106b of the shuttle 1010.

The first 1104a and second 1104b capacitors are arranged in a differential capacitance arrangement. Movement of the shuttle 1010 along the x-direction induces substantially equal and opposite changes in the output signals 1116 and 1118. As a result, the accelerometer 1100 provides a sensitivity output signal that is based on the difference between output signals 1106 and 1108.

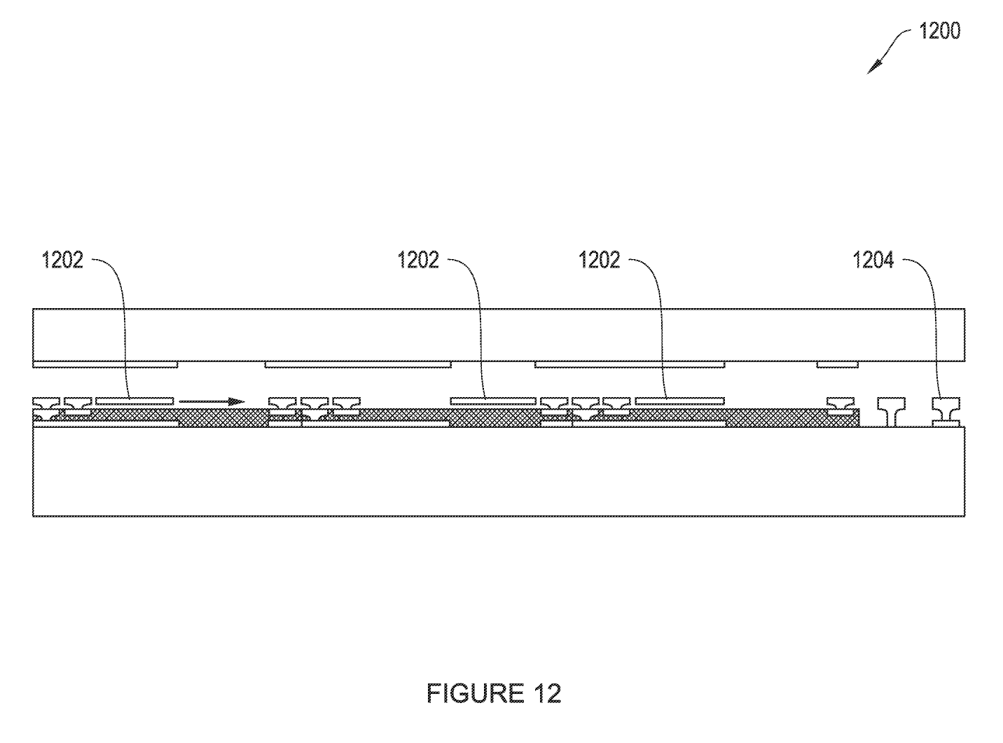

FIG. 12 shows a cross-sectional view of an example of a set of shutters 1202 and an accelerometer 1204 formed on a substrate 1206. The capacitive sensor built onto the sidewall beams of a compliant beam can be formed on the same substrate as the MEMs shutters that modulate light for the display. The accelerometer 1204 is substantially the same as the accelerometer 958 discussed above. The accelerometer 1204 may be incorporated into a tilt sensor that can be used to detect the orientation of the display in space.

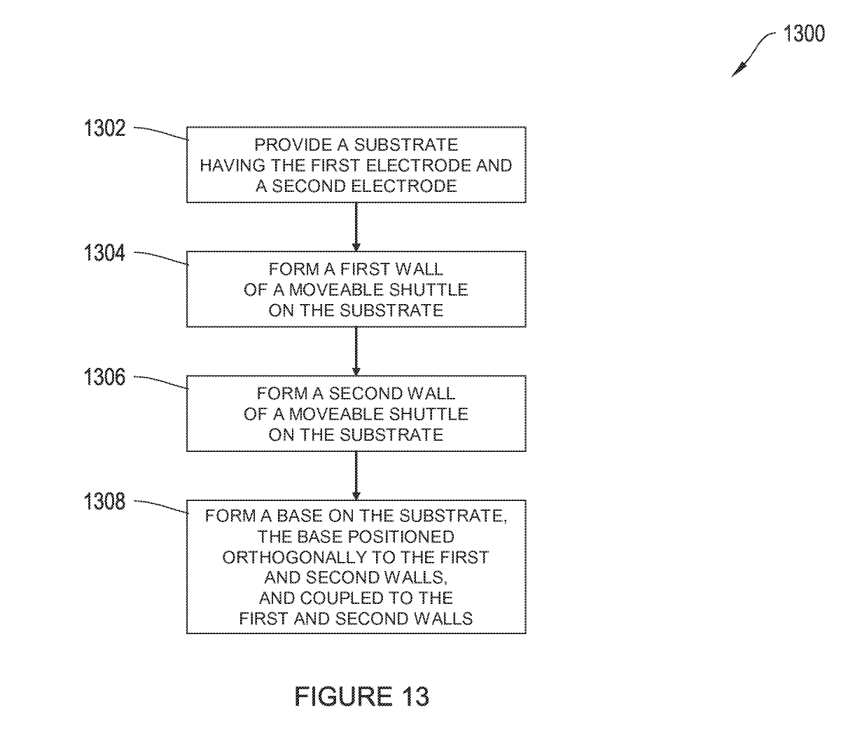

FIG. 13 shows a flowchart of a method 1300 of manufacturing an electromechanical device, according to one example. At block 1302, a substrate having a first electrode and a second electrode is provided. At block 1304, a first wall of a movable shuttle is formed on the substrate. At block 1306, a second wall of the movable shuttle is formed on the substrate. The first and second walls each define a vertical side of a monolithically formed movable shuttle. Additionally, the first and second walls each have a first dimension that is at least four times larger than a second dimension. At block 1308, a base is formed on the substrate. The base is positioned orthogonally to the first and second walls and defines a horizontal bottom of the shuttle. The first and second walls are coupled to the base to form a corrugated structure. As described with respect to FIGS. 9A, 9B, 10, 11A and 11B above, the first wall and the first electrode define a first capacitor, and the second wall and the second electrode define a second capacitor.

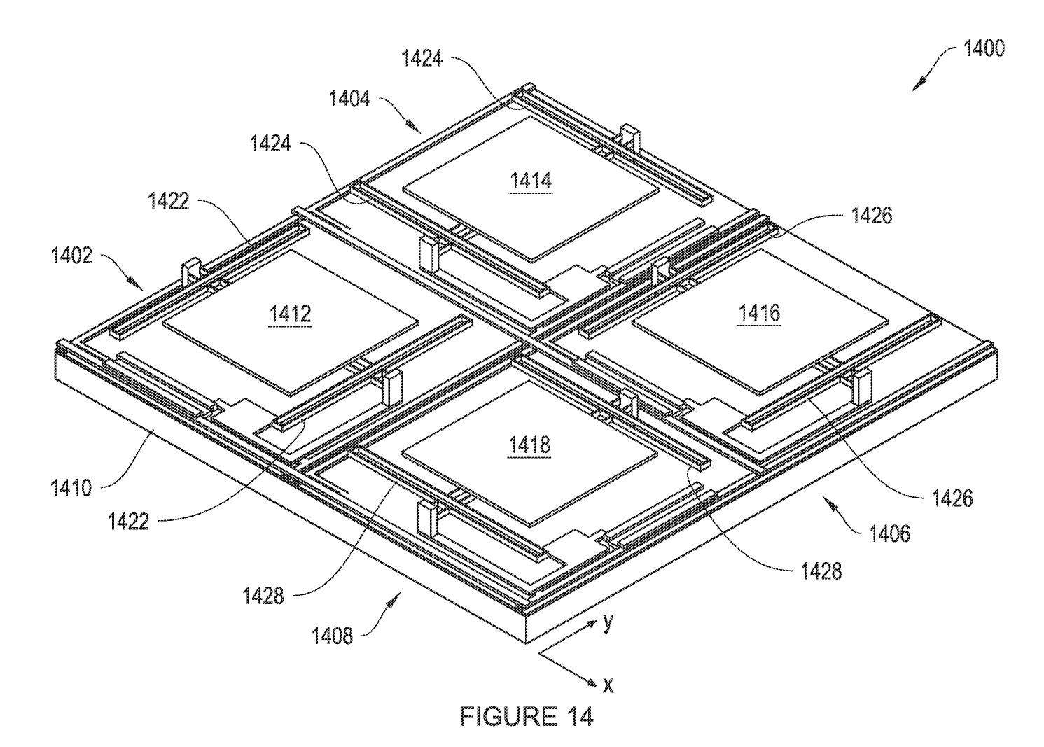

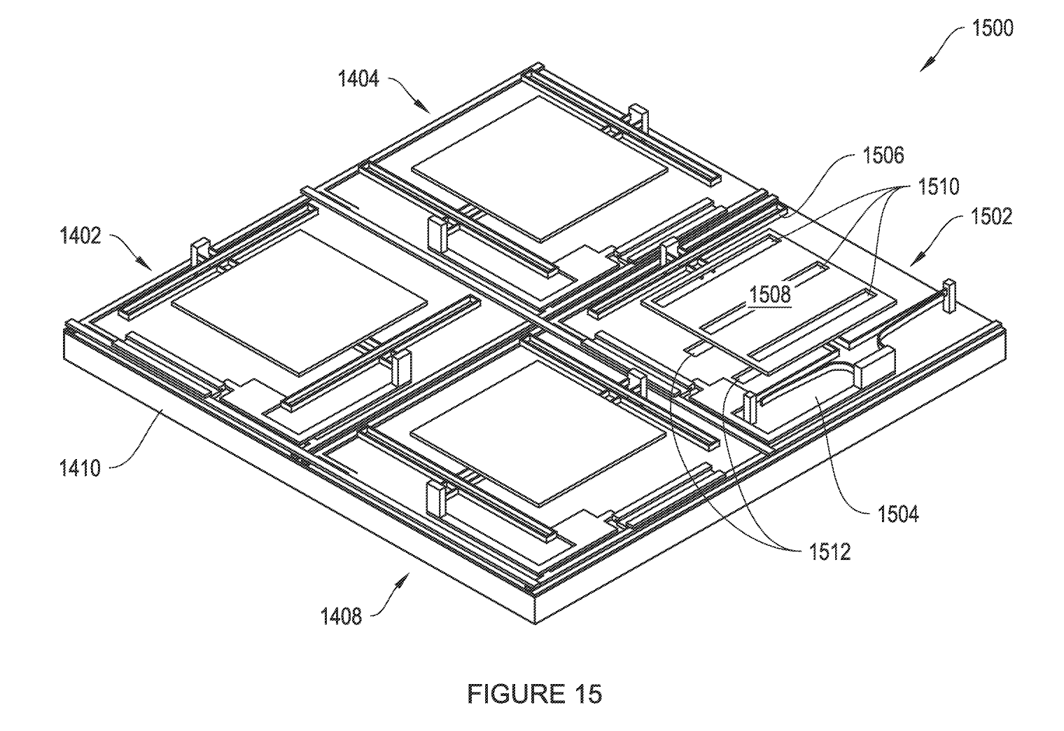

FIG. 14 is a perspective view of a MEMS gyroscope array 1400, including first 1402, second 1404, third 1406 and fourth 1408 MEMS gyroscopes. The MEMS gyroscope array 1400 measures the orientation of the device in which it is included. According to one feature, an array of gyroscopes 1400 provides more accurate gyroscope measurements than a single gyroscope, since any errors can be averaged out. The first 1402, second 1404, third 1406 and fourth 1408 MEMS gyroscopes each include a gyroscope element—first 1412, second 1414, third 1416 and fourth 1418 gyroscope elements, respectively. The first 1412, second 1414, third 1416 and fourth 1418 gyroscope elements are supported above the substrate 1410 by first 1422, second 1424, third 1426 and fourth 1428 springs, respectively.

According to one implementation, the first 1412 and third 1416 gyroscope elements vibrate along the x-axis, with the first gyroscope element 1412 vibrating between the first springs 1422 and the second gyroscope element 1416 vibrating between the second springs 1426. The second 1414 and fourth 1416 gyroscope elements vibrate along the y-axis, with the second gyroscope element 1414 vibrating between the second springs 1424 and the fourth gyroscope elements 1416 vibrating between the fourth spring 1428. Movement of each of the gyroscopes is measured and can be used to determine movement of the substrate 1410.

According to one implementation, an electrode may be included in one or more of the springs 1422, 1424, 1426, and 1428, and the electrodes may interact with the gyroscope elements 1412, 1414, 1416, and 1418 to form a capacitive element in each gyroscope 1402, 1404, 1406 and 1408. The capacitive element may be used to measure the vibrations of the gyroscope elements 1412, 1414, 1416 and 1418, for example, by measuring the distance between the respective gyroscope element 1412, 1414, 1416 and 1418 and the respective spring 1422, 1424, 1426 and 1428.

According to one implementation, the MEMS gyroscope array 1400 is anchored on a glass substrate. Using a glass substrate rather than a silicon substrate can result in significant cost savings. According to another implementation, the MEMS gyroscope array 1400 is placed over an array of circuitry. For example, the MEMS gyroscope array 1400 may be placed over a thin film transistor. The thin film transistor can be used for sensing gyroscope movement, estimating error, and general control of the gyroscopes. In a further implementation, the MEMS gyroscope array 1400 is monolithically integrated with the substrate.

FIG. 15 is a perspective view of an array of MEMS elements 1500 including first 1402, second 1404, and fourth 1408 gyroscope elements and a shutter-based light modulator 1502. FIG. 15 illustrates that a gyroscope array can be easily integrated in a MEMS display device, and can be fabricated using the same process used for other MEMS elements on a MEMS display device. The shutter-based light modulator may be substantially similar to the shutter assembly 200 described above with respect to FIG. 2, and includes first apertures 1510 in the shutter element 1508 and second apertures 1512 in an aperture layer. An actuator 1504 is used to move the shutter element 1508 along the x-axis and control the alignment of the first apertures 1510 with the second aperture 1512.

The array of MEMS elements 1500 may be integrated into a display including a large array of shutters. For example, the array 1500 including the gyroscope elements 1402, 1404, and 1408 may be one corner of an array with hundreds or thousands of shutter elements. For example, the array of shutter elements 320 shown in FIG. 3B may be repeated hundreds of times, forming a display including an array with thousands of shutter elements, and a few of the shutter elements may be replaced with gyroscope elements 1402, 1404, and 1408 as shown in the array 1500. In this manner, a gyroscope array including just two or more gyroscope elements can be integrated into the shutter array of a display to provide gyroscope features such as information on orientation and/or movement of the display.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A device comprising:
a substrate having a first electrode and a second electrode; and
a movable shuttle monolithically integrated with the substrate, and having a first wall, a second wall, and a base,
wherein the first and second walls each have a first dimension at least four times larger than a second dimension,
wherein the first and second walls define substantially parallel vertical sides of the shuttle, and the base is positioned orthogonally to the first and second walls and forms a horizontal bottom of the shuttle, and
wherein the first wall and the first electrode define a first capacitor, and the second wall and the second electrode define a second capacitor.

2. The device of claim 1, wherein the base provides structural support to the first and second walls and limits movement of the first and second walls.

3. The device of claim 1, wherein
the first wall faces the first electrode in a first direction and the second wall faces the second electrode in a second opposite direction, to provide a differential capacitor sensor.

4. The device of claim 1, wherein
the substrate includes an insulator selected from the group comprising at least one of glass, fused silica, an insulating ceramic, and a polymeric insulator.

5. The device of claim 1, wherein
the substrate includes a transparent section, and
the movable shuttle includes a microelectromechanical (MEM) shutter element for modulating light passing through the transparent section of the substrate.

6. The device of claim 1, wherein
the movable shuttle includes a transducer of a component selected from a group comprising at least one of an accelerometer, a speaker, a microphone, and a pressure sensor.

7. The device of claim 1, further comprising a tether beam monolithically integrated with the substrate and configured to hold the movable shuttle relative to the substrate.

8. The device of claim 1, further comprising a microelectricalmechanical systems (MEMS) gyroscope array monolithically integrated with the substrate and configured to measure an orientation of the device.

9. The device of claim 1, further comprising:
a display;
a processor that is configured to communicate with the display, the processor being configured to process image data; and
a memory device that is configured to communicate with the processor.

10. The device of claim 9, further comprising:
a driver circuit configured to send at least one signal to the display; and
a controller configured to send at least a portion of the image data to the driver circuit.

11. The device of claim 9, further comprising:
an image source module configured to send the image data to the processor, wherein the
image source module comprises at least one of a receiver, transceiver, and transmitter.

12. The device of claim 9, further comprising:
an input device configured to receive input data and to communicate the input data to the processor.

13. A method of manufacturing an electromechanical device, comprising:
providing a substrate having a first electrode and a second electrode; and
monolithically forming a movable shuttle on the substrate, wherein forming the shuttle includes
forming a first wall and a second wall, each defining a vertical side of the shuttle and each having a first dimension at least four times larger than a second dimension, and
forming a base positioned orthogonally to the first and second walls and defining a horizontal bottom of the shuttle, wherein the first and second walls are coupled to the base to form a corrugated structure,
wherein the first wall and the first electrode define a first capacitor, and the second wall and the second electrode define a second capacitor.

14. The method of claim 13, wherein
forming the first wall includes forming the first wall to face the first electrode in a first direction, and
forming the second wall includes forming the second wall to face the second electrode in a second opposite direction,
wherein the method further comprises
configuring the first and the second capacitors to provide a differential capacitor sensor.

15. The method of claim 13, wherein monolithically forming the movable shuttle includes providing a MEM shutter element for modulating light passing through a transparent section of the substrate.

16. The method of claim 13, wherein monolithically forming the movable shuttle includes providing a transducer of a component selected from a group consisting of an accelerometer, a speaker, a microphone, and a pressure sensor.

17. The method of claim 13, further comprising providing a tether beam monolithically integrated with the substrate and configured to hold the movable shuttle relative to the substrate.

18. The method of claim 13, wherein providing the substrate includes providing an insulator selected from the group comprising at least one of glass, fused silica, an insulating ceramic, and a polymeric insulator.

19. A display comprising:
a substrate having a first electrode and a second electrode;
a plurality of microelectromechanical system (MEMS) shutters disposed on the substrate and configured to modulate light; and
a movable shuttle monolithically integrated with the substrate, and having a first wall, a second wall, and a base, wherein the first and second walls each have a first dimension at least four times larger than a second dimension, and wherein the first wall, the second wall, and the base are coupled to substantially define a U-shape, and
wherein the first wall and the first electrode define a first capacitor, and the second wall and the second electrode define a second capacitor.

20. The display of claim 19, wherein
the movable shuttle includes a transducer of a component selected from a group comprising at least one of an accelerometer, a speaker, a microphone, a tilt sensor, and a pressure sensor.

21. The display of claim 19, wherein
the first and second walls define parallel vertical sides of the shuttle,
the base is positioned orthogonally to the first and second walls, and
the base provides support to the first and second walls and limits movement of the first and second walls.

22. The display of claim 19, wherein
the first wall faces the first electrode in a first direction and the second wall faces the second electrode in a second opposite direction, to provide a differential capacitor sensor.

23. The display of claim 19, wherein
the substrate includes an insulator selected from the group comprising at least one of glass, fused silica, an insulating ceramic, and a polymeric insulator.

24. The display of claim 19, further comprising a tether beam monolithically integrated with the substrate and configured to hold the movable shuttle relative to the substrate.

25. The display of claim 19, further comprising a MEMS gyroscope array disposed on the substrate and configured to measure an orientation of the display, the MEMS gyroscope array including at least one gyroscope incorporating the movable shuttle.
